(19) United States
(12) Patent Application Publication
(10) Pub. No.: US 2018/0129873 A1
(43) Pub. Date: May 10, 2018

(54) EVENT DETECTION AND SUMMARISATION

(71) Applicant: UNIVERSITY OF ESSEX ENTERPRISES LIMITED, Colchester, Essex (GB)

(72) Inventors: Daniyal ALGHAZZAWI, Colchester, Essex (GB); Areej MALIBARI, Colchester, Essex (GB); Bo YAO, Colchester, Essex (GB); Hani HAGRAS, Colchester, Essex (GB)

(73) Assignee: University of Essex Enterprises Limited, Colchester, Essex (GB)

(21) Appl. No.: 15/566,949

(22) PCT Filed: Mar. 29, 2016
(86) PCT No.: PCT/GB2016/050863

§ 371 Date: Oct. 16, 2017

(30) Foreign Application Priority Data
Apr. 16, 2015 (GB) 1506444.7
Sep. 18, 2015 (GB) 1516555.8

(51) Int. Cl. G06K 9/00; G06N 5/04; G06K 9/62

(52) U.S. Cl. CPC G06K 9/00342; G06K 9/6223; G06N 5/048; G06K 9/00369

(57) ABSTRACT

A method and apparatus are disclosed for determining behaviour of a plurality of candidate objects in a multi-candidate object scene. The method comprises the steps of frame-by-frame, extracting behaviour features from video data associated with a scene, providing the behaviour features to an input of a recognition module comprising an interval Type 2 Fuzzy Logic (IT2FLS) based recognition model and classifying candidate object behaviour for a plurality of candidate objects in a current frame by selecting a candidate behaviour model having a highest output degree for each candidate object.

The present invention relates to a method and apparatus for detecting and/or summarising predetermined events and/or behaviour. In particular, but not exclusively, the present invention relates to a system which can detect certain behaviour for multiple people or predefined objects in a video stream and provide linguistic summarisation to frames in that video stream which help summarise the behaviour.

The World Health Organization (WHO) have estimated that in 2050, there will be 1.91 billion people aged 65 years and over worldwide. Hence, recently, there have been an increased interest in Ambient Assisted Living (AAL) technologies due to the increase of ageing population, shortage of caregivers and the increasing costs of healthcare. Employing advanced machine vision based systems for behaviour and event detection as well as event summarisation in AAL applications can help to increase the level of care and decrease the associated costs. In addition, machine vision based systems can help to detect and summarise important information which cannot be detected by any other sensor (like how much water did the candidate drink and did they eat or not, etc). However, the great expansion of deploying and utilising video sensors can lead to massive amounts of redundant video data which require high associated costs related to data storage in addition to the human resources spent on watching or manually extracting key video information. This problem is becoming increasingly obvious as the number of video cameras in use is estimated to be 100 million worldwide and the estimated number of in-use cameras is 5.9 million in the United Kingdom which owns the largest number of Closed-Circuit Television (CCTV) cameras in the world.

Conventional video systems based on human monitoring are highly labour-intensive since watching and analysing video content uses a higher level of concentrated attention. It has been reported that maintaining the necessary attention and reacting to rare events from multiple input video channels is a very challenging task which is also extremely prone to error due to the degradation in the engagement level. Thus, there is a dramatically growing demand to develop real-time video detection and automatic linguistic summarisation tools which are capable of autonomously detecting important events instantly and summarising in layman terms the interesting information from the massive raw video data in AAL applications. To automatically detect serious events that need immediate attention, there is a need to analyse the real-time input data and provide valuable context information which cannot be extracted by other sensors. For example, an important application in elderly care within AAL environments is ensuring that the user drinks enough water throughout the day to avoid dehydration. Advantageously a system should also send a warning message to social services nearby in case an elderly person falls and needs help so that proper actions can be taken instantly. Furthermore, it would be advantageous if electric appliances could be intelligently tuned and controlled according to the user's behaviour and activity to maximise their comfort and safety while minimising the consumed energy.

Many AAL and healthcare applications have been reported based on behaviour and activity recognition. Single activity monitoring systems have been proposed to analyse a single activity. For example a method has been introduced to analyse the behaviour of watching TV for diagnosing health conditions. Elsewhere researchers have proposed an algorithm to analyse walking patterns in order to notify the elderly users to avoid the risk of falling down.

However, a single activity analysis system is unable to recognise other important behaviours and is not sufficient to create an effective AAL environment. In J. Wan, C. Byrne, G. O'Hare, and M. O'Grady, “Orange alerts: Lessons from an outdoor case study,” Proceedings of 5th International Conference on Pervasive Computing Technologies for Healthcare, IEEE, pp. 446-451, 2011, Wan et al. developed a behaviour recognition system to prevent the wandering behaviour of dementia patients and notify the caretakers if deviation from predefined routes is detected. For the prevention of indoor stray, Lin et al. C. Lin, M. Chiu, C. Hsiao, R. Lee, and Y. Tsai, “Wireless health care service system for elderly with dementia,” IEEE Transactions on Information Technology in Biomedicine, vol. 10, no. 4, pp. 696-704, 2006 utilised RFID sensors to detect if a dementia patient approached an unsafe region in order to avoid potentially injurious situations. However, these kinds of location and trajectory-based systems can only estimate the status of the subject via the position rather than recognising the actual behaviour and activity. Remote telecare systems can be constructed by using AAL based on activity recognition. For example Barnes et al. N. Barnes, N. Edwards, D. Rose, and P. Garner, “Lifestyle monitoring technology for supported independence,” Computing & Control Engineering Journal, vol. 9, pp. 169-174, August 1998 presented a low-cost solution to realising an intelligent telecare system by utilising the infrastructure of British Telecom to assess the lifestyle feature data of the elderly. The system proposed used IR sensors, magnetic contacts and temperature sensors to collect the data of the temperature and the user's movement. An alarm could be sent to a remote telecare centre and the caregivers if abnormal behaviour is detected. However, the system is simple and is limited to only recognising abnormal sleeping duration, uncomfortable environmental temperature, and fridge usage disarray. Hoey et al. J. Hoey, K. Zutis, V. Leuty and A. Mihailidis, “A tool to promote prolonged engagement in art therapy: design and development from arts therapist requirements,” Proceedings of the 12th international ACM SIGACCESS conference on Computers and accessibility, pp. 211-218, 2010 introduced a cognitive rehabilitation system using AAL technologies to help the elderly with dementia. Another known cognitive orthotics system analyses a model of the everyday activity plan according to multi-level events, and evaluated the patient's implementation of the plan for the purpose of cognitive orthotics. However, extendable recognition for complex behaviour and activity together with the summarisation of the frequency, duration, timestamp and the user information is not implemented in these conventional systems.

Conventionally behaviour and activity recognition has tended to be based on 2D video data or RFID sensors. However, 2D video data based sensors are normally inadequate for capturing robust visual detailed features especially for those highly complex vision applications such as behaviour recognition. Hence, the use of 2D video data in real-world environments leads to relatively low accuracy due to the noise and uncertainties associated with sunshine, shadow, occlusion and colour similarity, etc. The use of RFID tags is intrusive and inconvenient as it requires a deployment of RFID tags on the human or objects. Dynamic models of behaviour characteristics can be constructed by utilising statistics-based algorithms, for example Conditional Random Fields (CRF) and Hidden Markov Model (HMM). However, accuracy has been found to be a problem. Dynamic Time Warping (DTW) is another classic algorithm that has conventionally been used for behaviour recognition. However, DTW only returns exact values and thus is inadequate for modelling the behaviour uncertainty and activity ambiguity.

Machine vision based behaviour recognition and summarisation in real-world AAL has proved challenging due to the high levels of encountered uncertainties caused by the large number of subjects, behaviour ambiguity between different people, occlusion problems from other subjects (or non-human objects such as furniture) and the environmental factors such as illumination strength, capture angle, shadow and reflection, etc. To handle the high-levels of uncertainty associated with the real-world environments, Fuzzy Logic Systems (FLSs) have been proposed. Various linguistic summarisation methods based on Type-1 FLSs (T1FLSs) have been proposed which employed T1FLSs for fall down detection. These type-1 fuzzy-based approaches perform well in predefined situations where the level of uncertainty is low. But these methods require multi-camera calibration which is inconvenient and time-consuming.

T1FLSs have been used to analyse the input data from wearable devices to recognise the behaviour and summarise the human activity. However, such wearable devices are intrusive and could be uncomfortable and inconvenient as the deployment of wearable devices is invasive for the skin and muscles of the users. T1FLS have been disclosed in B. Yao, H. Hagras, M. Alhaddad, D. Alghazzawi, “A fuzzy logic-based system for the automation of human behavior recognition using machine vision in intelligent environments,” Soft Computing, pp. 1-8, 2014 to analyse the spatial and temporal features for efficient human behaviour recognition. In K. Almohammadi, B. Yao, and H. Hagras, “An interval type-2 fuzzy logic based system with user engagement feedback for customized knowledge delivery within intelligent E-learning platforms,” Proceedings of IEEE International Conference on Fuzzy Systems (FUZZ-IEEE), pp. 808-817, 2014, fuzzy logic was employed to recognise students' engagement degree so as to evaluate their performance in an online learning system. However, there are intra- and inter-subject variations in behavioural characteristics which cause high levels of uncertainty in the behaviour recognition.

In “A Big Bang-Big Crunch Optimisation for a Type-2 Fuzzy Logic based Human Behaviour Recognition System in Intelligent Environments” July 2014, Bo Yao and Hani Hagras el disclosed a human recognition system, however this related to a high level system that did not provide for analysis for multiple candidate objects. Furthermore, the system did not provide a scalable skeleton analysis system for multiple candidate objects that enables new behaviour/s to be detected to be added. As such the prior art system only enables ‘hard wired’ skeleton analysis for few behaviours which cannot be scaled to add more behaviours. Still furthermore, the disclosed system provides no disclosure for the learning of membership functions and rules from data and tuning them using the big bang-big crunch optimisation method to provide improved results. In addition, a recognition phase was not detailed.

It is an aim of the present invention to at least partly mitigate one or more of the above-mentioned problems.

It is an aim of certain embodiments of the present invention to provide a system which can receive video input in the format of frames provided by one or more sensors and detect the behaviour of predetermined objects, such as people, in those video frames.

It is an aim of certain embodiments of the present invention to be able to automatically detect the behaviour of multiple people shown at any one time in a video stream.

It is an aim of certain embodiments of the present invention to accurately determine behaviour of multiple people or other such objects in an unstructured scene captured by one or more sensors.

It is an aim of certain embodiments of the present invention to provide a linguistic summarisation tool to add easily recognisable linguistic marks to a frame or frames of a captured video sequence responsive to the determination of certain behaviour observed for predetermined object types.

According to a first aspect of the present invention there is provided a method of determining behaviour of a plurality of candidate objects in a multi-candidate object scene, comprising the steps of:
frame-by-frame, extracting behaviour features from video data associated with a scene;
providing the behaviour features to an input of a recognition module comprising an Interval Type 2 Fuzzy Logic (IT2FLS) based recognition model; and
classifying candidate object behaviour for a plurality of candidate objects in a current frame by selecting a candidate behaviour model having a highest output degree for each candidate object.

Aptly the method further comprises selecting said a candidate behaviour model by selecting a one candidate model from a plurality of possible candidate behaviour models of the recognition model, each possible candidate behaviour model being allocated a respective output degree for a target candidate object in a frame and said a one candidate behaviour model being the candidate model having the highest output degree.

Aptly the method further comprises selecting said a candidate model by selecting a candidate behaviour model from at least one confident candidate behaviour model that has a calculated confidence level above a predetermined threshold.

Aptly the method further comprises providing behaviour features as a crisp feature vector M, that models behaviour characteristics in a current frame, given by:

M=(m₁,m₂,m₃,m₃,m₅,m₆,m₇)

where M, is a motion feature vector and m₁ is an angle feature of the left arm, m₂ is an angle feature of the left arm θₐᵣ, m₃ and m₄ are position features Dₕₗ, Dₕᵣ of the vectors \vec{PₛₛPₕₗ}, \vec{PₛₛPₕᵣ}, m₆ is a bending angle, m₆ is a distance D_{f} between 3D coordinates Spine Base P_{sb} to the 3D Plane of the floor in the vertical direction, and m₇ is the movement speed D_{sb}.

Aptly the method further comprises via a type 2 singleton fuzzifier, fuzzifying the crisp input vector thereby providing an upper and lower membership value.

Aptly the method further comprises determining a firing strength for each of R rules.

Aptly the method further comprises determining a reduced set defined by the interval:

[Yₗₖ,Yᵣₖ]
where Yₗₖ Yᵣₖ are the left and right end points of type reduced sets.

Aptly the method further comprises determining an output degree via a defuzzification step.

Aptly the method further comprises providing video data of the scene via at least one sensor element.

Aptly the method further comprises continually monitoring a scene via a plurality of high definition (HD) video sensors each providing a respective stream of consecutive image frames.

Aptly the method further comprises as predetermined events are detected, determining at least one associated information element and providing corresponding summarised event data for the detected event; and
storing the summarised event data in a database.

Aptly the method further comprises storing the summarised event data in the database as a record associated with a particular frame or range of frames of video data.

According to a second aspect of the present invention there is provided a method of providing an interval Type 2 Fuzzy Logic (IT2FLS) based recognition module for a video monitoring system that can determine behaviour of a plurality of candidate objects in a multi candidate object scene, comprising the steps of:
frame-by-frame extracting features from video data depicting at least one candidate object performing a predetermined behaviour;
providing Type-1 fuzzy membership functions for the extracted features;
transforming each Type-1 membership function to a Type-2 membership function; and
generating an initial rule base including a plurality of multiple input-multiple output rules responsive to the extracted features.

Aptly the method further comprises for each behaviour to be recognised by the recognition module, providing a feature vector M, that models behaviour characteristics of a predetermined behaviour, given by:

M=(m₁,m₂,m₃,m₃,m₅,m₆,m₇)

where M is a motion feature vector and m₁ is an angle feature of the left arm, m₂ is an angle feature of the left arm θₐᵣ,m₃ and m₄ are position features Dₕₗ, Dₕᵣ of the vectors \vec{PₛₛPₕₗ}, \vec{PₛₛPₕᵣ}, m₅ is a bending angle, m₆ is a distance D_{f} between 3D coordinates Spine Base P_{sb} to the 3D Plane of the floor in the vertical direction, and m₇ the movement speed D_{sb}.

Aptly the method further comprises encoding parameters of the generated rule base into a form of a population.

Aptly the method further comprises providing an optimised rule base for the recognition module via big bang-big crunch (BB-BC) optimisation of the initial rule base.

Aptly the method further comprises encoding feature parameters of the Type-2 membership function into a form of a population.

Aptly the method further comprises providing an optimised Type-2 membership function for the recognition module via big bang-big crunch (BB-BC) optimisation of the Type-2 membership function.

Aptly the method providing Type-1 fuzzy membership functions further comprises via a clustering method that classifies unlabelled data by minimising an objective function.

Aptly the method further comprises providing the video data by continuously or repeatedly capturing an image at a scene containing a candidate object via at least one sensor element.

Aptly the method further comprises extracting features by providing at least one of a joint-angle feature representation, a joint-position feature representation, a posture representation and/or a tracking reliability status for joints identified.

According to a third aspect of the present invention there is provided a product which comprises a computer program comprising program instructions for determining behaviour of a plurality of candidate objects in a multi-candidate object scene by the steps of:
frame-by-frame, extracting behaviour features from video data associated with a scene;
providing the behaviour features to an input of a recognition module comprising an Interval Type 2 Fuzzy Logic System (IT2FLS) based recognition module; and
classifying candidate object behaviour for a plurality of candidate objects in a current frame by selecting a candidate behaviour model having a highest output degree for each candidate object.

According to a fourth aspect of the present invention there is provided apparatus for determining behaviour of a plurality of candidate objects in a multi-candidate object scene, comprising:
at least one sensor for providing video data associated with a scene;
at least one feature extraction module for extracting behaviour features from the video data; and
at least one Interval Type 2 Fuzzy Logic System (IT2FLS) based recognition module for receiving the behaviour features and classifying candidate object behaviour for a plurality of candidate objects in a current frame by selecting a candidate behaviour model having a highest output degree for each candidate object.

Aptly the apparatus further comprises at least one data base searchable by the steps of inputting one or more behaviour marks and providing one or more frames comprising image data including at least one candidate object having a predetermined behaviour associated with the input mark/s.

According to a fifth aspect of the present invention there is provided apparatus for recognising behaviour of at least one person in a multi-person environment, comprising:
at least one sensor;
an input feature extraction module for extracting a plurality of features for at least one person in an image containing a plurality of people;
a rule base comprising learnt rules; and
a Type-2 Fuzzy Logic System (FLS) based recognition module;
   wherein
at least one behaviour is determined responsive to an output from the recognition module.

According to a sixth aspect of the present invention there is provided a method for recognising at least one behaviour of at least one person in a multi-person environment, comprising the steps of:
via at least one sensor, providing at least one image of a person in a multi-person environment;
from the image, extracting a plurality of features for at least one person in the image;
providing data associated with the extracted features to a Type-2 Fuzzy Logic System (FLS) recognition module; and
determining at least one behaviour responsive to an output from the recognition module.

Aptly the apparatus or method has a rule base that includes parameters tuned according to a Big Bang Big Crunch (BB-BC) optimisation strategy.

Aptly the apparatus or method includes a Type-2 FLS having parameters of each associated membership function tuned according to a BB-BC optimisation strategy.

Aptly the method or apparatus further includes a searchable back end system comprising a database which can be searched by the steps of inputting one or more behaviour marks and providing one or more frames comprising image data including at least one person showing a predetermined behaviour associated with the input mark/s

Aptly the environment is an unstructured environment.

Aptly one or more images include a part or fully occluded person.

According to a seventh aspect of the present invention there is provided a method or apparatus for extracting features in a learning or recognition phase comprising:
for each tracked subject, for example a person, in a frame, determining a motion feature vector M as:

M=(θₐₗ,θₐᵣ,Dₕₗ,Dₕᵣ,θ_{b},D_{f},D_{sb})

According to an eighth aspect of the present invention there is a provided a method substantially as hereinbefore described with reference to the accompanying drawings.

According to a ninth aspect of the present invention there is provided apparatus constructed and arranged substantially as hereinbefore described with reference to the accompanying drawings.

According to certain aspects of the present invention there is provided a method and apparatus for determining behaviour of a plurality of candidate objects in a multi candidate object scene.

According to certain embodiments of the present invention there is provided a robust behaviour recognition system for video linguistic summarisation using the latest model of the 3D Kinect camera based on Interval Type-2 Fuzzy Logic Systems (IT2FLSs) optimised by Big Bang Big Crunch (BB-BC) algorithm to obtain the parameters of the membership functions and rule base of the IT2FLS. Aptly the BB-BC IT2FLSs outperform their conventional Type-1 FLSs (T1FLSs) counterparts as well as other conventional non-fuzzy methods, and a performance improvement rises when the amount of subjects increases.

Aptly by utilising the recognised output activity together with relevant event descriptions (such as video data, timestamp, location and user identification) detailed events can be efficiently summarised and stored in a back-end SQL event database which provides services including event searching, activity retrieval and high-definition video playback to the front-end user interfaces.

Certain embodiments of the present invention provide an automated real time and accurate system including an apparatus and methodology for event detection and summarisation in real-world environments.

Certain embodiments of the present invention will now be described hereinafter, by way of example only, with reference to the accompanying drawings in which:

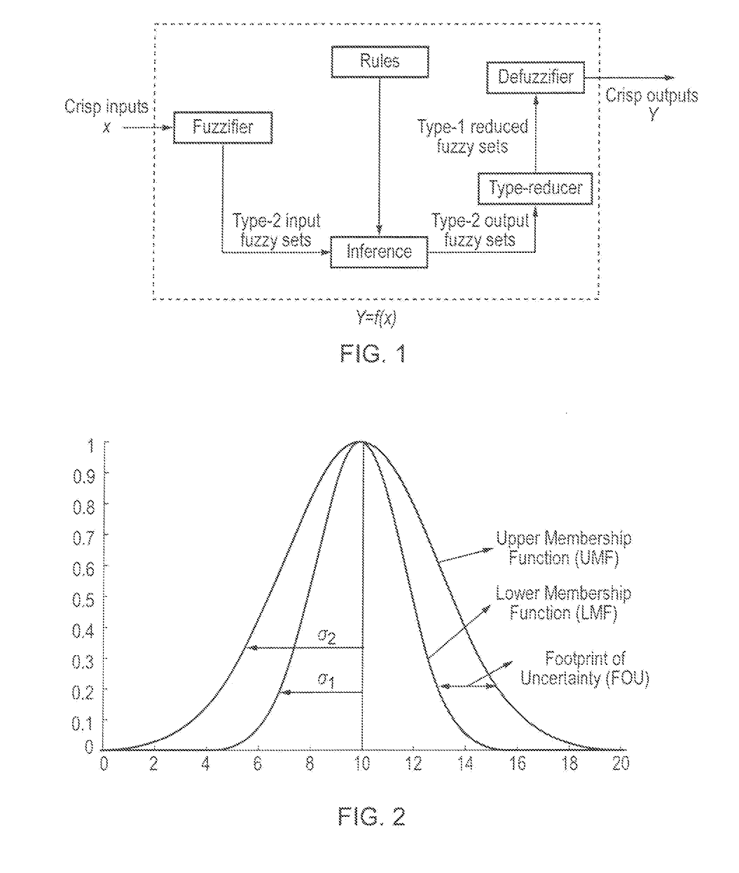

FIG. 1 illustrates a structure of a type-2 fuzzy logic set;

FIG. 2 illustrates an interval type-2 fuzzy set;

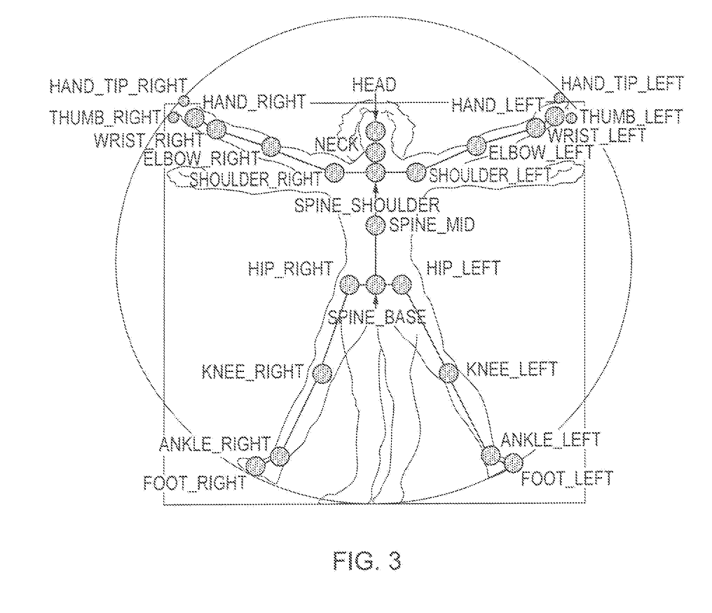

FIG. 3 illustrates joints (predetermined points on a predetermined object/subject) on a body of a person;

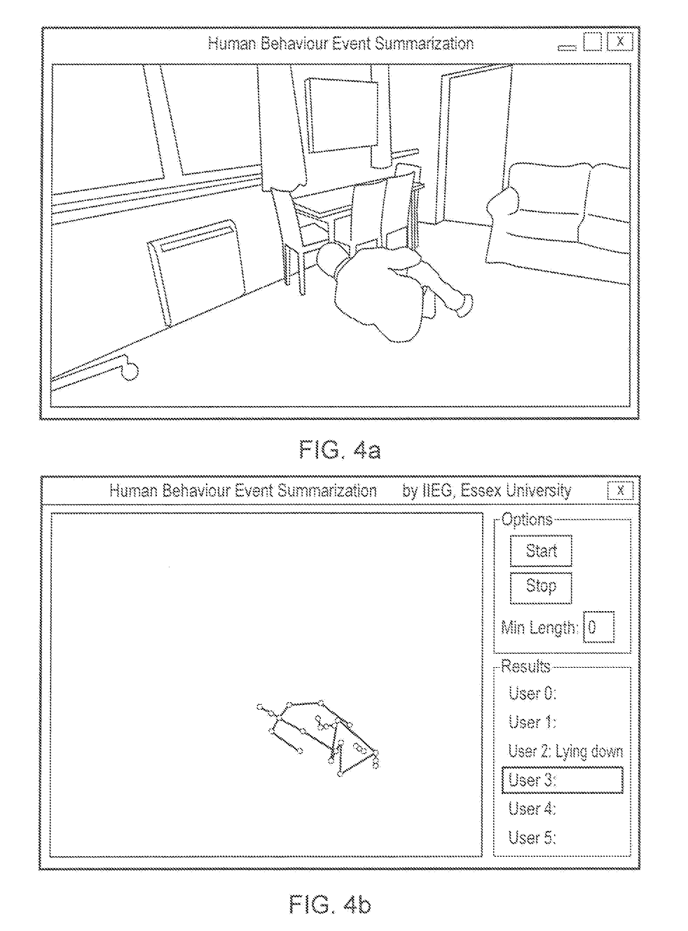

FIG. 4 illustrates part of a user interface;

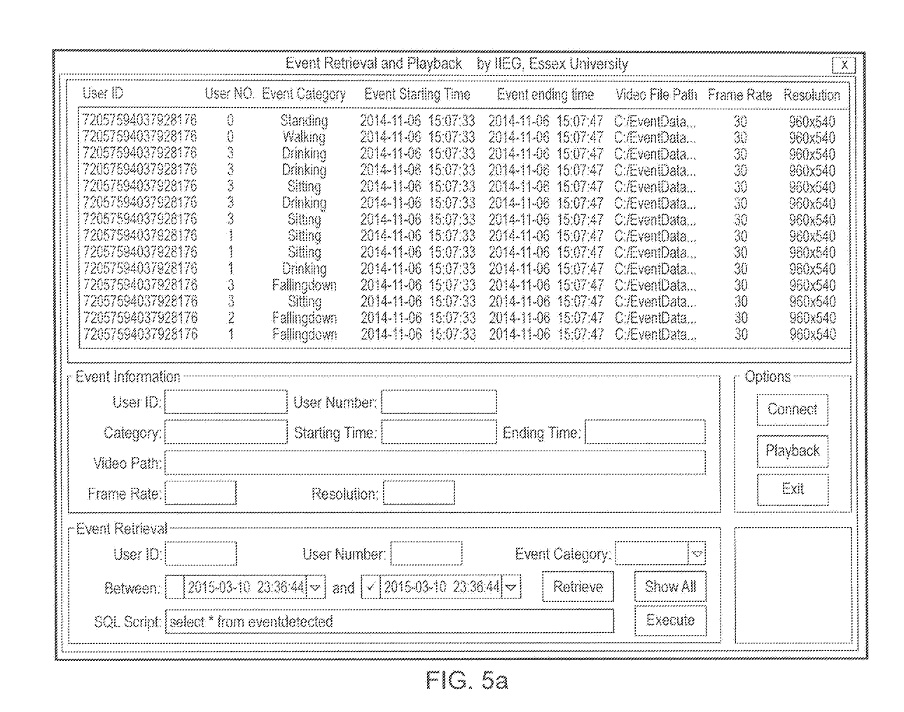

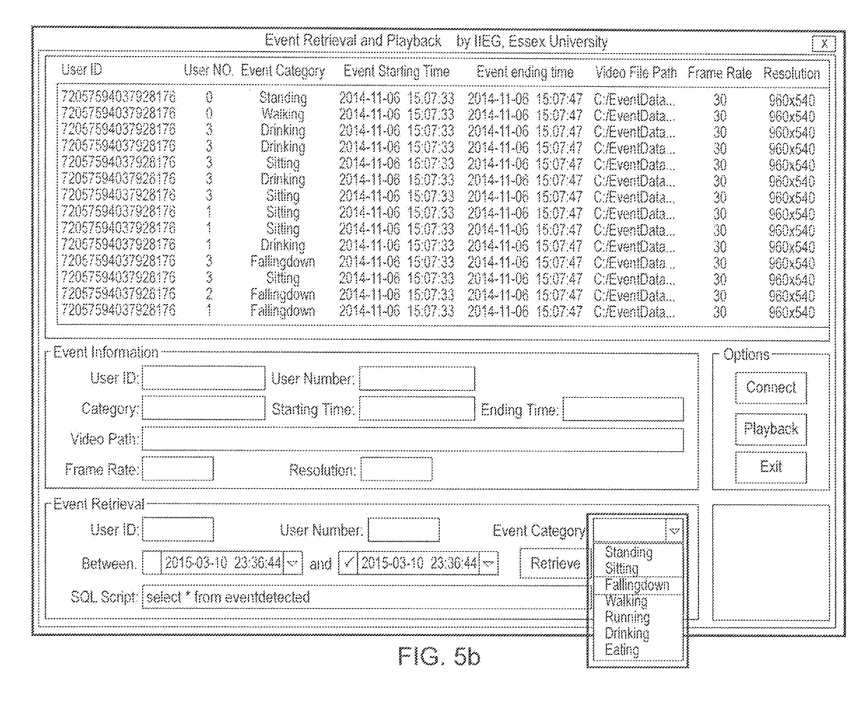

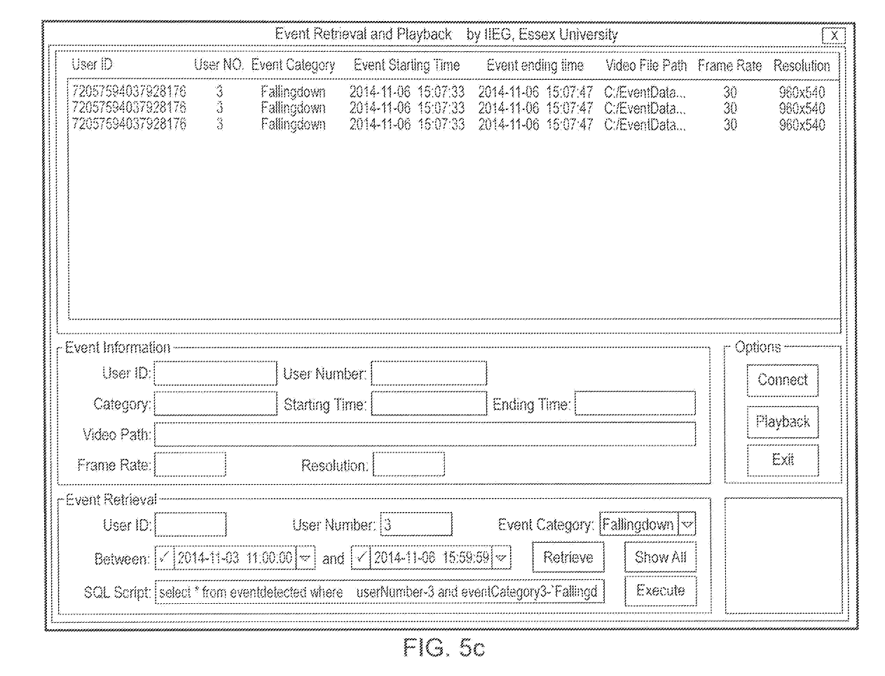

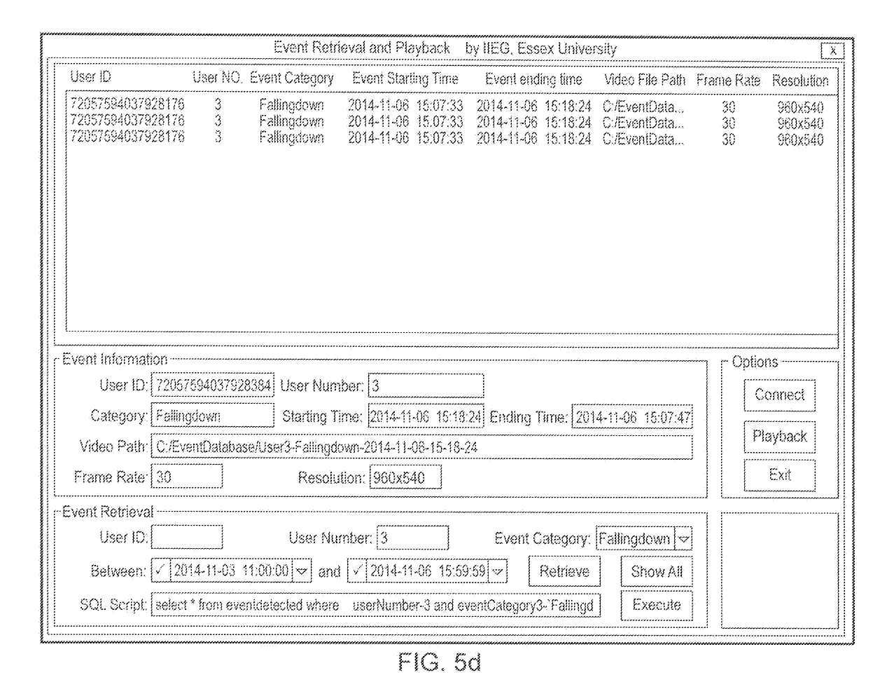

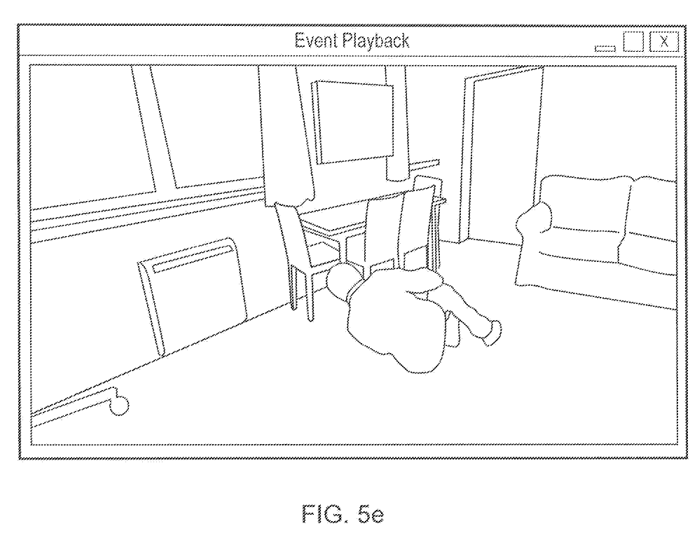

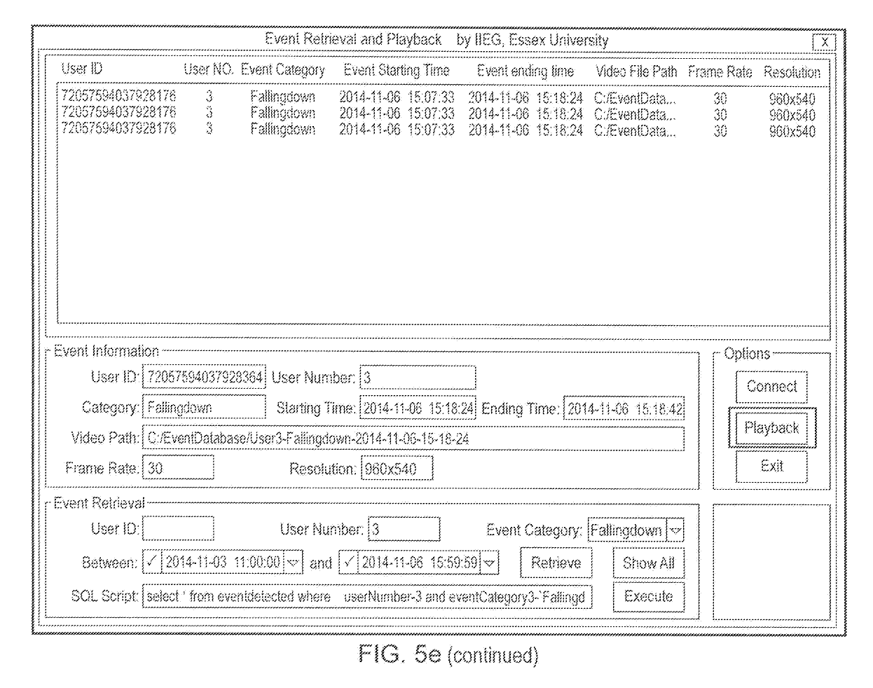

FIG. 5 illustrates another part of a user interface;

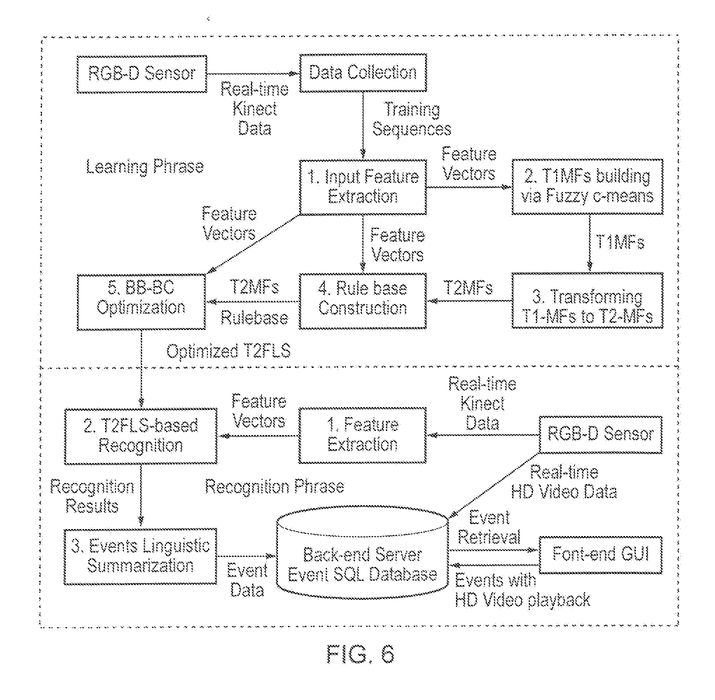

FIG. 6 illustrates a learning phase and a recognition phase;

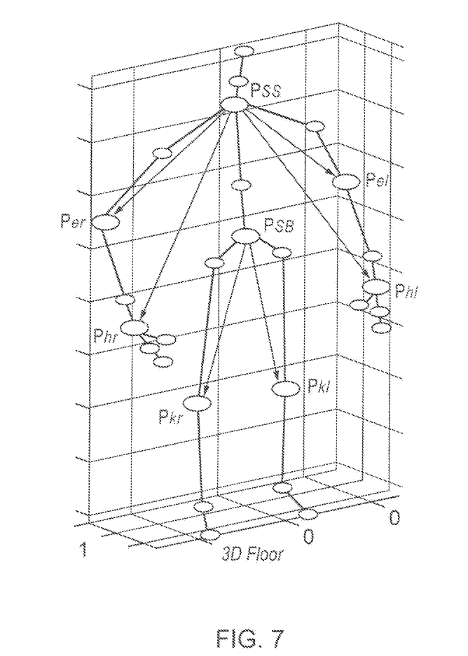

FIG. 7 illustrates 3D feature vectors based on the Kinect v2 skeletal model;

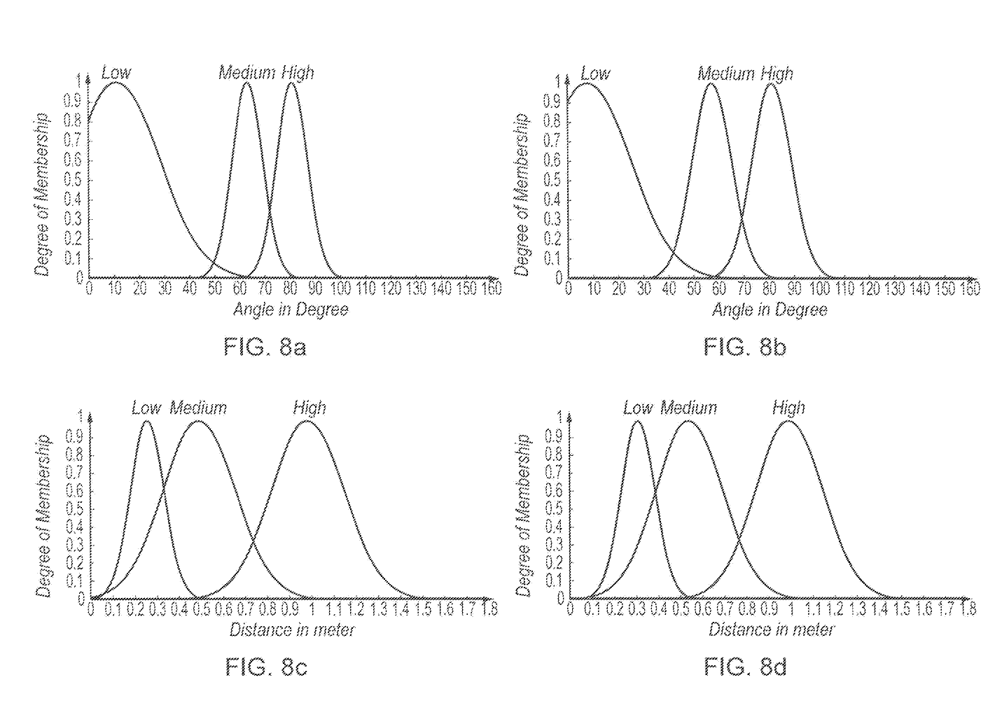

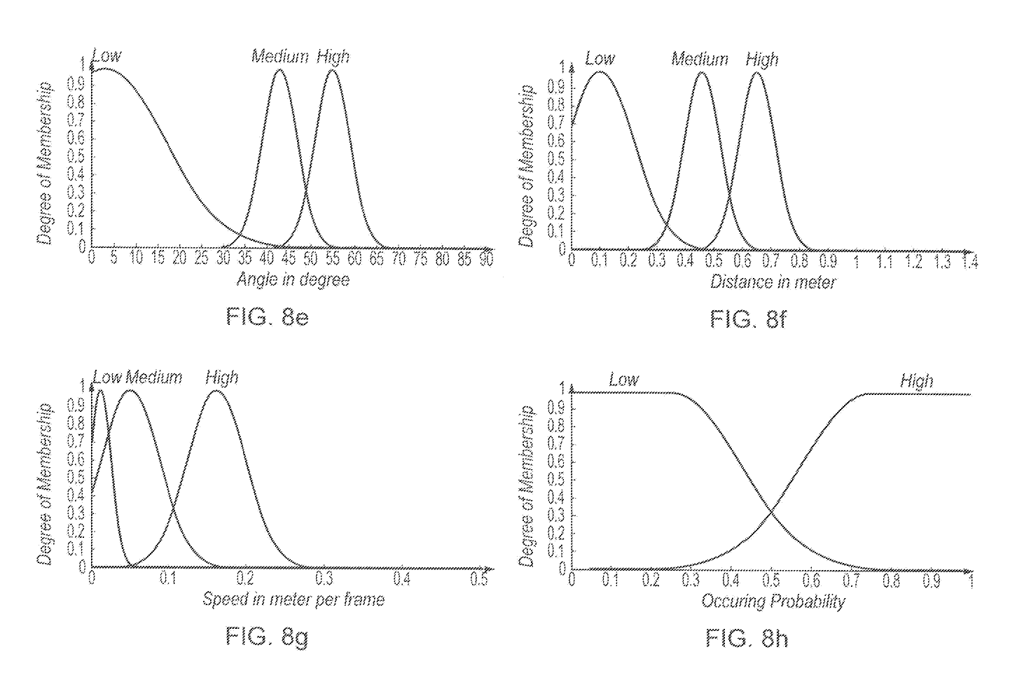

FIG. 8 illustrates Type-1 membership functions constructed by using FCM, (a) Type-1 MF for m₁ (b) Type-1 MF for m₂ (c) Type-1 MF for m₃ (d) Type-1 MF for m₄ (e) Type-1 MF for m₅ (f) Type-1 MF for m₆ (g) Type-1 MF for m₇ (h) Type-1 MF for the Outputs;

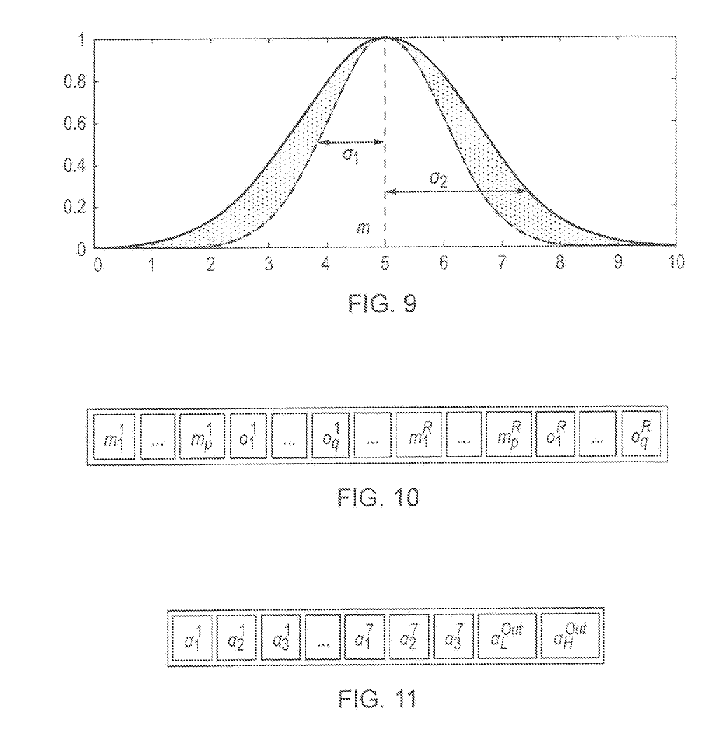

FIG. 9 illustrates an example of the type-2 fuzzy membership function of the Gaussian membership function with uncertain standard deviation a where the shaded region is the Footprint of Uncertainty (FOU) and the thick solid and dashed lines denote the lower and upper membership functions;

FIG. 10 illustrates the population representation for the parameters of the rule base;

FIG. 11 illustrates the population representation for the parameters of type-2 MFs;

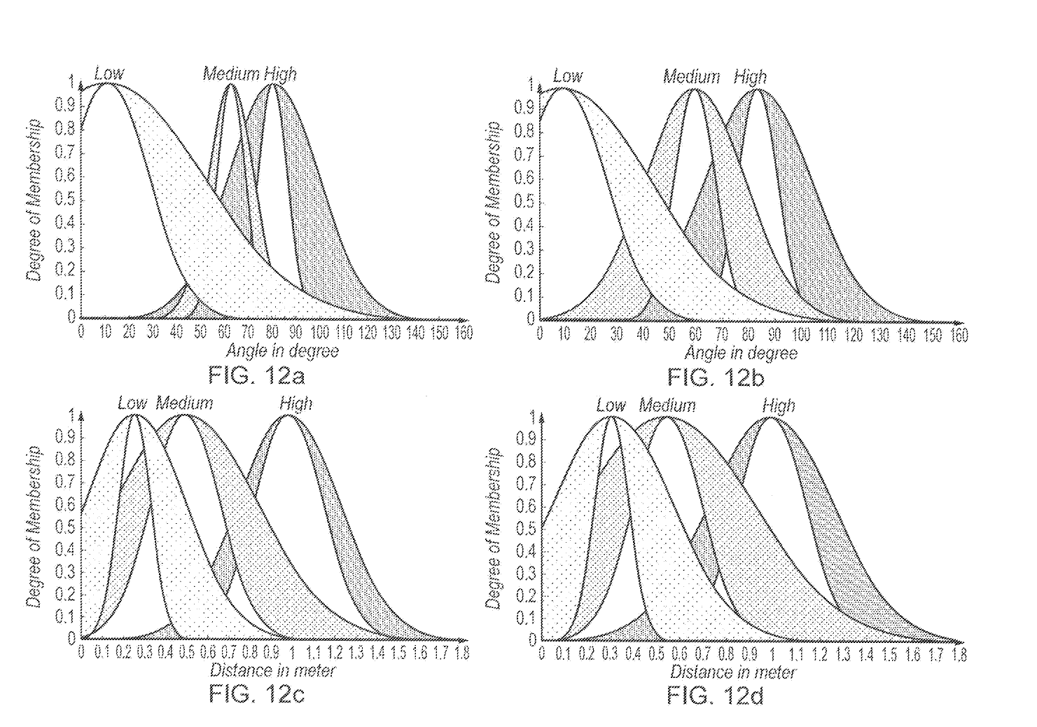

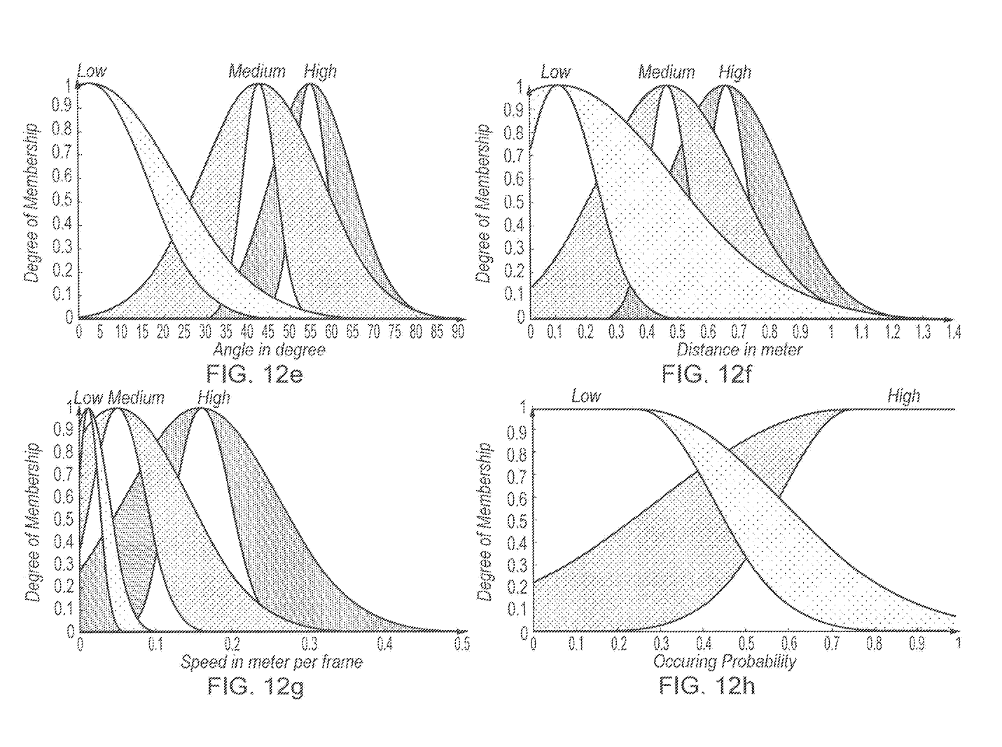

FIG. 12 illustrates Type-2 membership functions optimised by using BB-BC, (a) Type-2 MF for m₁ (b) Type-2 MF for m₂ (c) Type-2 MF for m₃ (d) Type-2 MF for m₄ (e) Type-2 MF for m₅ (f) Type-2 MF for m₆ (g) Type-2 MF for m₇ (h) Type-2 MF for Output;

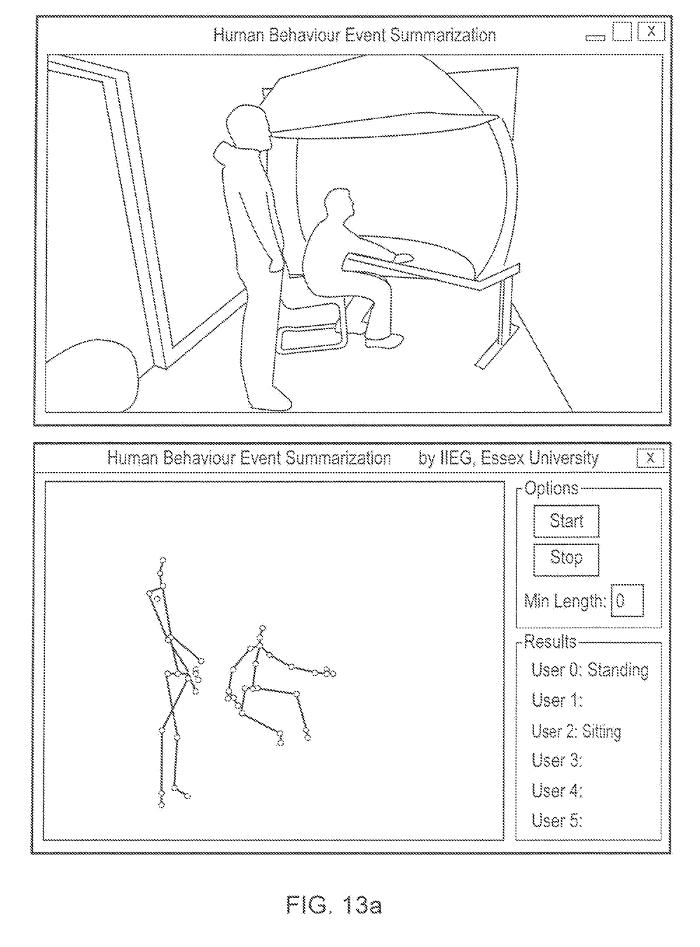

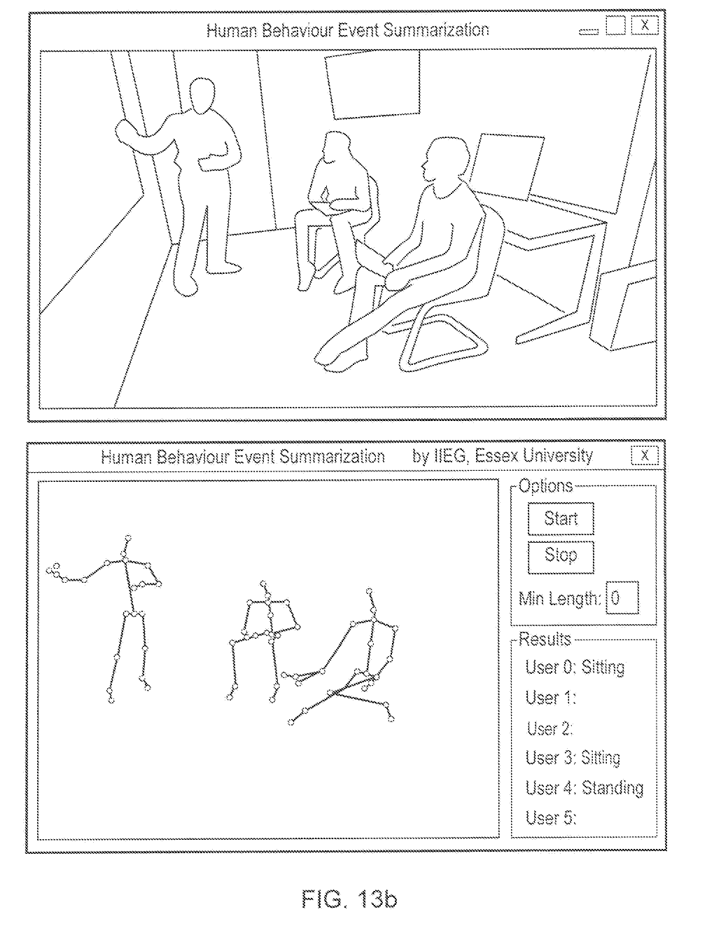

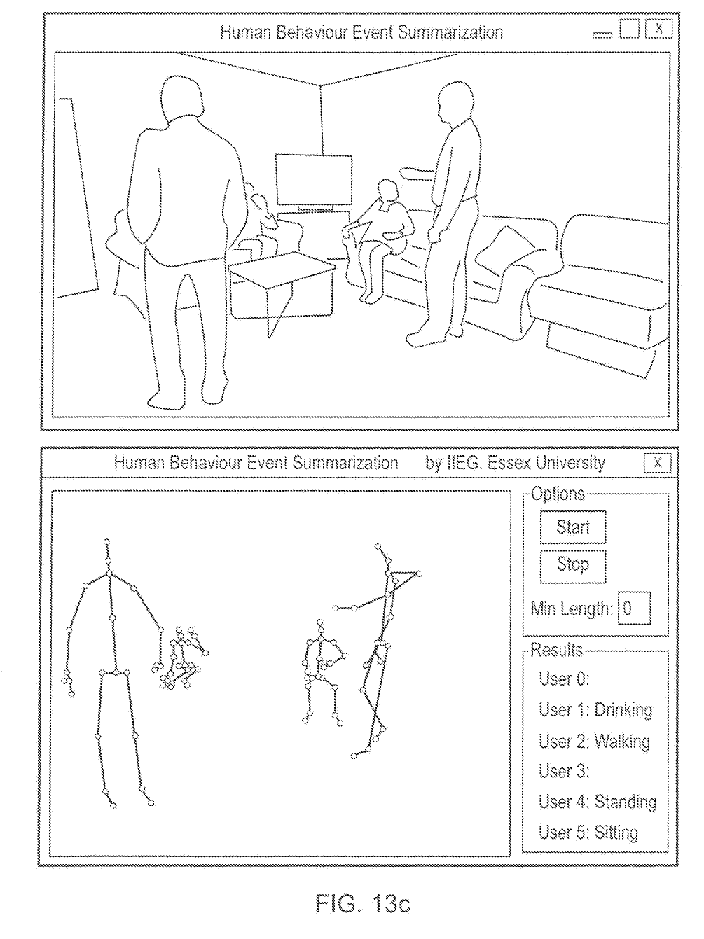

FIG. 13 helps illustrate detection results from a real-time T2FLS-based recognition system, (a) recognition results in a room with two subjects in the scene (b) recognition results in a room with three subjects in the scene (c) recognition results in a room with four subjects in the scene leading to occlusion problems and high-levels of uncertainty; and

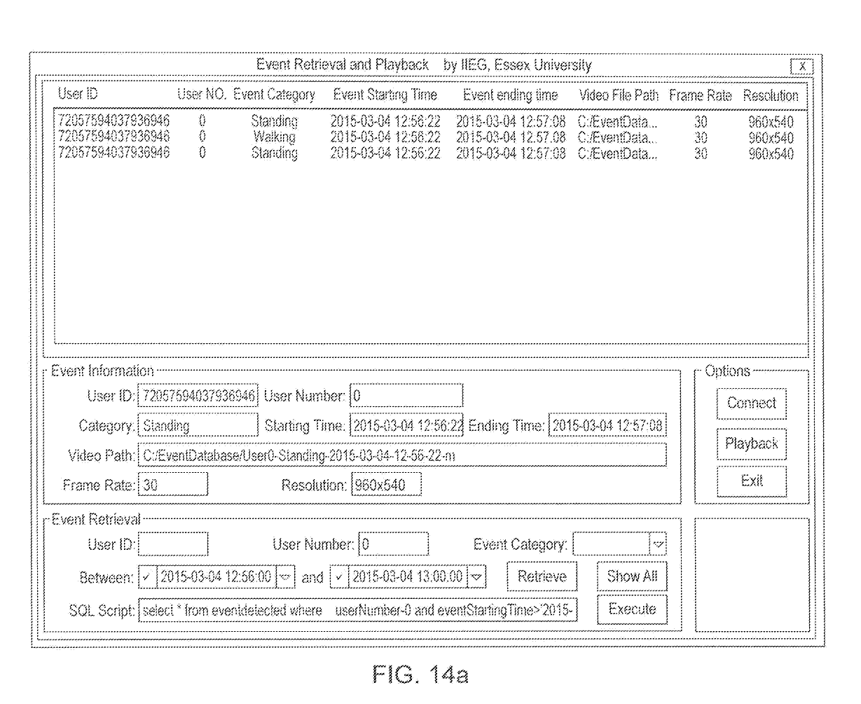

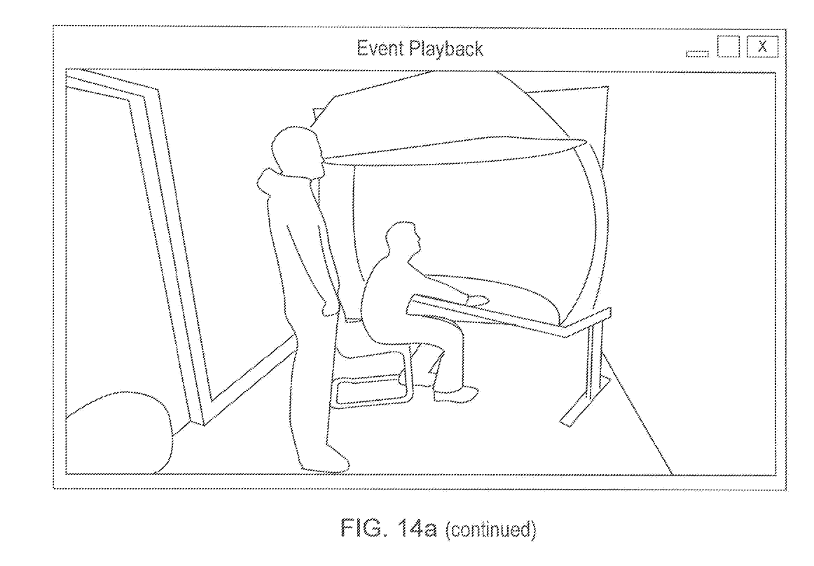

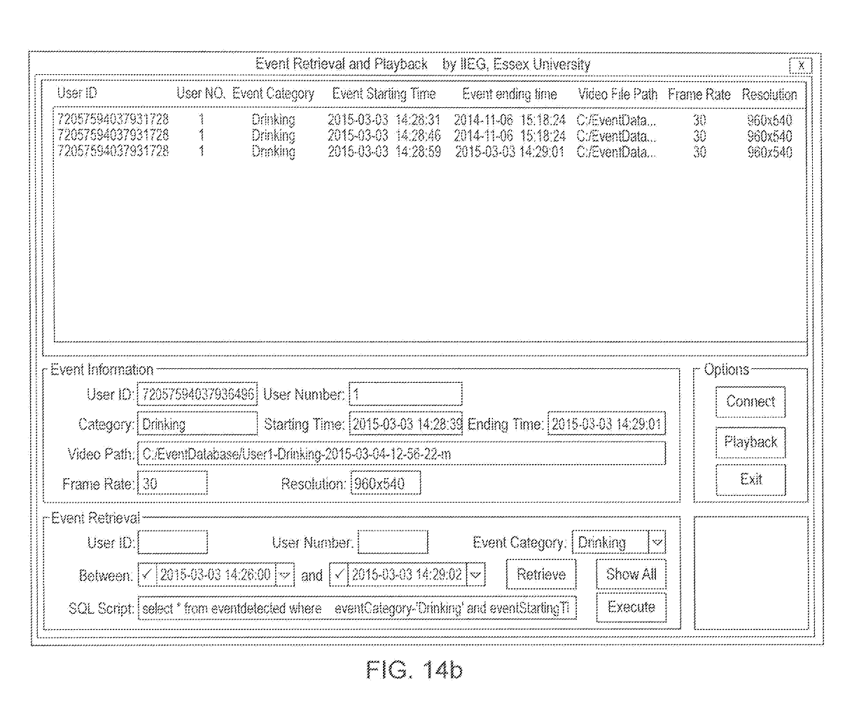

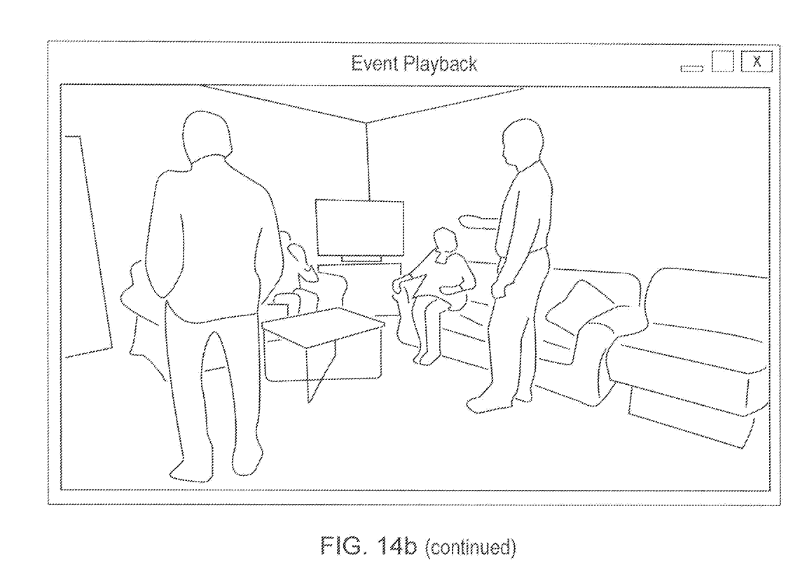

FIG. 14 helps illustrate retrieval of events and playback.

In the drawings like reference numerals refer to like parts.

The IT2FLS shown in FIG. 1 uses the interval type-2 fuzzy sets shown in FIG. 2 to represent the inputs and/or outputs of the FLS. In the interval type-2 fuzzy sets all the third dimension values are equal to one. The use of interval type-2 FLS helps to simplify the computation of the type-2 FLS. The interval type-2 FLS works as follows: the crisp inputs from the input sensors are first fuzzified into input type-2 fuzzy sets. Singleton fuzzification can be used in interval type-2 FLS applications due to its simplicity and suitability for embedded processors and real-time applications. The input type-2 fuzzy sets then activate the inference engine and the rule base to produce output type-2 fuzzy sets. The type-2 FLS rule base remains the same as for a type-1 FLS but its Membership Functions (MFs) are represented by interval type-2 fuzzy sets instead of type-1 fuzzy sets. The inference engine combines the fired rules and gives a mapping from input type-2 fuzzy sets to output type-2 fuzzy sets. The type-2 fuzzy output sets of the inference engine are then processed by the type-reducer which leads to type-1 fuzzy sets called the type-reduced sets. There are different types of type-reduction methods. Aptly use can be made of the Centre of Sets type-reduction as it has a reasonable computational complexity that lies between the computationally expensive centroid type-reduction and the simple height and modified height type-reductions which have problems when only one rule fires. After the type-reduction process, the type-reduced sets are defuzzified (by taking the average of the type-reduced set) so as to obtain crisp outputs.

Sensors are used to detect person (or other predetermined object) motion. Aptly one or more Kinect v2 sensors are used. The Kinect is the most popular RGB-D sensor in recent years. Most of the other RGB-D sensors such as ASUS Xtion and PrimeSense Capri use the PS1080 hardware design and chip from PrimeSense which was bought by Apple in 2013. These or other sensor types can of course be used according to certain embodiments of the present invention.

The original Kinect v1 camera was first introduced in 2010 and was mainly used to capture users' body movements and motions for interacting with the program, but was rapidly repurposed to be utilised in a diverse array of novel applications from healthcare to robotics.

It has been repurposed in the field of intelligent environments and robotics as an affordable but robust replacement for various types of wearable sensors, expensive distance sensors and conventional 2D cameras. It has been successfully used in various applications including object tracking and recognition as well as 3D indoor mapping and human activity analysis. However, the structured-light technology of Kinect v1 limited the usage of its depth camera in outdoor environments where it cannot sense minor objects, and had depth resolutions (320×240) and field of view (57°×43°) that were too low to satisfy the needs and requirements of some of the real-world application scenarios. By contrast, the new generation Kinect v2 was improved to employ time-of-flight range sensing where the infrared camera ejects strobe infrared light into the scene, and calculates the time length for the bursts of light to return to each pixel. In this way, its infrared camera can produce high-resolution (512×424) depth images at the field of view of 70°×60°, and at the same time, Kinect v2 produces high-resolution (up to 1920×1080) colour images at the field of view of 84°×53° using a build-in colour camera which performs as well as a regular high-definition (HD) CCTV camera. One of the extra merits of the Kinect v2 is its low price at about £130 as well as its convenient software development kit (SDK) which can return various robust features such as 3D skeleton data for rapid development and research.

For most of the user-oriented applications in intelligent environments and healthcare, the features of the user posture, especially skeleton data, make up the core information since the skeleton data describes the skeleton joint positions and orientations of the user in the scene. Aptly, according to certain embodiments of the present invention, a skeleton tracker is used. Aptly the Kinect skeleton tracker is used. There are of course several alternative skeleton trackers available including Kinect skeleton tracker, Open Natural Interaction (OpenNI/NiTE) skeleton tracker, and Point Cloud Library (PCL) skeleton tracker and these could optionally alternatively be used. For the Kinect skeleton tracker, a random decision forest-based method is used in Kinect v1 to robustly extract the 20 joints from one subject. In the SDK of Kinect v2, the skeleton tracker is improved and can robustly extract up to 25 3D joints as shown in FIG. 3 from a single user (with new joints for hands and neck, etc.) and handles the occlusion problem of different users and readily supports multiple users in a scene at the same time. The effective sensing range of the Kinect skeleton tracker is from 0.4 meters to 4.5 meters. In the PrimeSense's OpenNI, a skeleton tracker was provided and can extract the positions of 15 joints from a single user. For the PCL skeleton tracker, 15 joints can be analysed from a subject. The module requires a video card supporting nVidia CUDA.

The system detects one or more multiple behaviours. Aptly the system detects six behaviours which are useful for AAL activities. These are falling down, drinking/eating, walking, running, sitting and Standing. Other behaviours could of course be detected according to use.

The GUI of the system has two parts where the first part is shown in FIG. 4a and is used during the video capture and shows the detected behaviours and can send immediate alerts for important events like falling down. The left part of FIG. 4 (FIG. 4a) illustrates original colour high-definition video which is continuously captured and displayed. Black and white video could optionally be utilised. The right part of FIG. 4 (FIG. 4b) illustrates the captured 3D skeleton data (highlighted in FIG. 4b) of the subject in the current frame. The GUI shows also the detected behaviours for multiple users/objects. Aptly up to six users in the current frame can be detected and behaviour assessed. As can be shown in FIG. 4, the system can detect the event of “falling down/lying down” under strong sunshine illumination and shadow changes. Since this event detection is connected to a back-end event database, once an activity is detected, the system summarises the relevant details of an event (e.g. subject identification, subject number, behaviour category, event time stamp, event video data, etc) regarding the detected behaviour will be efficiently stored so that event retrieval and playback can later be performed by the users using the front-end GUI system. Optionally, if the detected event is an urgent emergency, a warning message may be sent to relevant caregivers so that instant action can be taken.

The second part of the GUI is shown in FIG. 5 and it deals with the event retrieval, linguistic summarisation and playback. FIG. 5a shows the initial appearance of the GUI where the connection between the GUI to the back-end event SQL server is built automatically. After data is generated and populated in the database a user can search for the events of interest by entering their searching criterions including the options of identification of the subject, the number of the subject, event category, and event timestamp. An example has been given in FIG. 5, where the user has selected searching the event category “Fallingdown” from a target behaviour list For further refinement of the retrieval criteria, the particular subject number as well as a fixed time period described by the exact starting date and time and the ending date and time of the event timestamp can be provided by the user. After clicking the “Retrieve” button, the front-end GUI will translate the current searching criterions into SQL scripts via an edit box “SQL script” (for further editing of complex and advanced searching if necessary). Then the translated SQL scripts will be sent from the front-end GUI to the back-end event database server to retrieve the relevant events according to the requests of the user. Then the retrieved events with details including subject information, event descriptions, and the relevant video clips will be sent from the back-end event server to the front-end GUI. The results of event retrieval are depicted in the list showing the relevant activities which have previously been detected and stored, as shown in FIG. 5d. The details of the selected event in the retrieval list is shown in the event information section, and the retrieved events can be used to play back the video matching the sequences the user wants to see as shown in FIG. 5e.

The back-end event database provides storage of the detected events including the event details such as subject identification, subject number, event category, event starting time, event ending time, and the associated high-definition video of the event or the like. The event SQL database provides the services of event search and retrieval for different front-end user interfaces so that the user can locally or remotely retrieve the interesting events and play them back.

FIG. 6 provides an illustration of the system in more detail. There are two phases in the system which are the learning phase and the recognition phase. In the learning phase, the training data for each behaviour category are collected from the real-time Kinect data captured from the subjects in different circumstances and situations. Then behaviour feature vectors based on the distance and angle feature information are computed and extracted from collected Kinect data so as to model the motion characteristics. From the results of the features extraction, the type-1 fuzzy Membership Functions (T1MFs) of the fuzzy systems are then recognised/known/discovered via Fuzzy C-Means Clustering (FCM). After that, the type-2 fuzzy MFs are produced by using the obtained type-1 fuzzy sets as the principal membership functions which are then blurred by a certain percentage to create an initial Footprint of Uncertainty (FOU). Then, with the learned membership functions, the rule base of the type-2 fuzzy system is constructed automatically from the input feature vectors. Finally, a method based on the BB-BC algorithm is used to optimise the parameters of the IT2FLS which will be employed to recognise the behaviour and activity in the recognition phase.

Aptly initial fuzzy sets and rules for the FLSs are generated and then optimised via the BB-BC approach as such initial fuzzy sets and rules provide a good starting point for the BB-BC to converge fast to an optimal position.

During the recognition phase, the real-time Kinect data and HD video data are captured continuously by the RGB-D sensor or multiple sensors monitoring the scene. From the real-time Kinect data, behaviour feature vectors are firstly extracted and used as input values for the IT2FLSs-based recognition system. In the fuzzy system, each behaviour model is described by the corresponding rules, and each output degree represents the likelihood between the behaviour in the current frame and the trained behaviour model in the knowledge base. The candidate behaviour in the current frame is then classified and recognised by selecting the candidate model with the highest output degree. Once important events are detected by the optimised IT2FLS, linguistic summarisation is performed using the key information such as the output action category, the starting time and ending time of the event, the user's number and identification, and the relevant HD video data and video descriptions. After that, the summarised event data is efficiently stored in a back-end server of event SQL database from where users can access locally or remotely by using the front-end Graphical User Interface (GUI) system and perform event searching, retrieval and playback.

### Learning Phase

1.1 Fuzzy c-Means

The Fuzzy c-mean (FCM) algorithm developed by Dunn, J. Dunn, “A fuzzy relative of the ISODATA process and its use in detecting compact, well separated cluster,” Cybernetics, vol. 3, no. 3, pp. 32-57, 1973, and later improved by Bezdek, N. Pal and J. Bezdek, “On cluster validity for the fuzzy c-means model,” IEEE Transaction on Fuzzy Systems, vol. 3, pp. 370-379, 1995, is an unsupervised clustering method to classify the unlabelled data by minimising an objective function. The FCM uses fuzzy partitioning such that each data point belongs to a cluster to a certain degree modelled by a membership degree in the range [0, 1] which indicates the strength of the association between that data point and a particular cluster centroid. Let X={x₁, x₂, . . . , x_{N}} be a set of given data points and V={v₁, v₂, . . . , v_{N}} be a set of cluster centres. The idea of the FCM is to partition the N data points into C clusters based on minimisation of the following objective function:

J(X;U,V)=Σᵢ₌₁^{N}Σⱼ₌₁^{C}uᵢⱼ^{m}∥xᵢ−vⱼ∥² (1)

where m is used to adjust the weighting effect of membership values, ∥⋅∥ is the Euclidean norm modelling the similarity between the data point and the centre, and U=(uᵢⱼ)_{C×N} is a fuzzy partition matrix subject to:

Σᵢ₌₁^{C}uᵢⱼ=1, ∀j=1, . . . , N (2)

and

uiJ∈[0,1], ∀i=1, . . . , C, ∀j=1, . . . , N (3)

Where uᵢⱼ is the membership degree of point xᵢ to the cluster j. The FCM is performed via an iterative procedure with the Equation (1) updating uᵢⱼ and cⱼ. The FCM is used to compute the clusters of each feature to generate the type-1 fuzzy membership functions for the fuzzy-based recognition system. The optimisation procedure of FCM can be summarised by the following steps:

Step 1: Set the iteration terminating threshold ε to a small positive number in the range [0, 1], the weighting exponent m, and the number of clusters C (in our system, ε is set to be 0.0005, m is initialised by using small positive random numbers ranging in [0, 1] and C is set to be 3 representing the fuzzy sets LOW, MEDIUM, HIGH) and set the number of iterationt=0.
Step 2: Increase the number of iteration t by 1
Step 3: Calculate the cluster centres by using the following equation:

$${v}_{i}^{( t )} = \frac{{\sum }_{j = 1}^{N} {( {u}_{ij}^{( t - 1 )} )}^{m} {x}_{j}}{{\sum }_{j = 1}^{N} {( {u}_{ij}^{( t - 1 )} )}^{m}} , ∀ i = 1 , … , C \qquad ( 4 )$$

Step 4: Compute all the uᵢⱼ using the following equation to update the fuzzy partition matrix by the newly obtained uᵢⱼ

$${u}_{ij}^{( t )} = \frac{1}{{\sum }_{k = 1}^{C} {( ‖ \frac{{x}_{j} - {v}_{i}^{( t )}}{{x}_{j} - {v}_{k}^{( t )}} ‖ )}^{\frac{2}{m - 1}}} , ∀ i = 1 , … , C , ∀ j = 1 , … , N \qquad ( 5 )$$

Step 5: Check if ∥U^{(t)}−U^{(t-1)}∥²<ε then stop; otherwise go to Step 2.

These steps will help to identify the centre of each type-1 fuzzy set and the associated membership distribution. We will repeat the above steps for each input and output variable to extract their type-1 fuzzy sets membership functions.

### 1.2 Feature Extraction

### 1.2.1 Joint-Angle Feature Representation

For each frame, the skeleton is a sequence of graphs with 15 joints, where each node has its geometric position represented as a 3D point in a global Cartesian coordinate system. For any three different 3D points P₁, P₂, and P₃, an angle feature θ is defined by these three 3D joints P₁, P₂ and P₃ at a time instant. The angle θ is obtained by calculating the angle between the vectors \vec{P₁P₂}, and \vec{P₂P₃} based on the following equation:

$$θ = {cos}^{- 1} ( \frac{\vec{{P}_{1} {P}_{2}} \times \vec{{P}_{2} {P}_{3}}}{\vert \vec{{P}_{1} {P}_{2}} \vert \vert \vec{{P}_{2} {P}_{3}} \vert} ) \qquad ( 6 )$$

### 1.2.2 Joint-Position Feature Representation

In order to model the local “depth appearance” for the joints, the joint positions are computed to represent the motion of the skeleton. For distance, between joint i and joint j, the arc-length distance is calculated:

Dᵢⱼ=∥Pᵢ−Pⱼ∥ (7)

where ∥⋅| is the Euclidean norm.

### 1.2.3 Posture Representation

To perform efficient behaviour recognition, an appropriate posture representation is essential to model the gesture characteristics. Aptly the Kinect v2 is used to extract the 3D skeleton data which comprises 3D joints which are shown in FIG. 7. After that, based on the 3D joints obtained, the posture feature is determined using the joint vectors as shown in FIG. 7. In the applications of AAL environments, the main focus is to understand a user's daily activities and regular behaviours to create ambient context awareness such that ambient assisted services can be provided to the users in the living environments. Therefore, in application scenarios of ambient assisted living environments, the system recognises and summarises the following behaviours: drinking/eating, sitting, standing, walking, running, and lying/falling down to provide different ambient assisted services. For example, if an elderly person is falling down, the system will send a warning message to the nearby caregivers or other relevant pre-identified people. Also the frequency of the drinking activity can be summarised to ensure that the user drinks enough water throughout the day to avoid dehydration. By the daily summarisation of the sitting and lying duration and frequency, healthcare advice can be provided if the user remains inactive/active most of the time. The detection results of running demonstrate a potential emergency happening. From the detection results of standing and walking, the location and trajectory of the subject can be determined so that services such as wandering prevention can be provided to dementia patients and the risk of falling down can be reduced by analysing the pattern of standing and walking. Furthermore, cognitive rehabilitation services can be provided to help the elderly with dementia by summarising this series of daily activities. Aptly to achieve robust recognition and summarisation of the behaviour in AAL environments, the angles and distance of the joint vectors can be used as the input features which are highly relevant when modelling the target behaviours in AAL environments. The identified behaviours are extendable to enlarge the recognition range of the target behaviour by adding any needed joints.

As most behaviours in daily activity such as drinking, eating, waving hands, taking pills, etc., are related to the upper body, in order to recognise desired behaviour and activity, the following joints can be monitored: spine base (P_{sb}), spine shoulder (Pₛₛ), elbow left (Pₑₗ), hand left (Pₕₗ), elbow right (Pₑᵣ), hand right (Pₕᵣ). The system's algorithm is highly extendable, more joints can easily be added and utilised for more application scenarios. The pose feature is obtained by calculating the joint-angle feature and joint-position feature of the selected joints, as given in the following procedure:

Step 1: Compute the vectors \vec{PₛₛPₑₗ}, \vec{PₛₛPₕₗ} modelling the left arm, and \vec{P_{sc}Pₑᵣ}, \vec{P_{sc}Pₑᵣ} modelling the right arm.
Step 2: Angle features of the left arm θₐₗ can be obtained by calculating the angle between vectors \vec{PₛₛPₑₗ}, \vec{PₛₛPₕₗ}, based on Equation (6). Similarly, angle features of the right arm θₐᵣ can be computed by applying the same process on \vec{PₛₛPₑᵣ}, \vec{PₛₛPₕₗ}.
Step 3: Based on Equation 7, position feature Dₕₗ, Dₕᵣ of the vectors \vec{PₛₛPₕₗ}, \vec{PₛₛPₕᵣ} can be obtained. In order to recognise activities, the status (3D position and angle) of the spine of the human subject is modelled in a way which is invariant to orientation and position, as shown below:
Step 4: Compute the vector \vec{PₛₛP_{sb}}, modelling the entire spine of the subject, and \vec{PₛₛPₖₗ}, \vec{PₛₛPₖᵣ} modelling the left knee and right knee. Compute the angle θₖₗ between \vec{PₛₛP_{sb}} and \vec{PₛₛPₖₗ} by using Equation (6). Similarly, the angle θₖᵣ can be obtained by applying Equation (6) on the vectors \vec{PₛₛP_{sb}} and \vec{PₛₛPₖᵣ}. Then, the bending angle θ_{b} of the body can be modeled, which is used mainly for analysing the sitting activity

θ_{b}=max(θₖₗ,θₖᵣ) (8)

Step 5: In order to recognise the lying/falling down activity, compute the distance D_{f} between the 3D coordinates Spine Base P_{sb} to the 3D Plane of the floor in the vertical direction.
Step 6: Compute the movement speed of the human by analysing P_{sb}ⁱ⁻¹ and P_{sb}ⁱ which are the positions of the joint P_{sb} in two successive frame i−1 and frame i. The speed D_{sb} can be obtained by applying Equation (7) on P_{sb}ⁱ⁻¹ and P_{sb}ⁱ. The movement speed D_{sb} is mainly utilised for analysing the common activities: falling down, sitting, standing, walking, and running.

For each tracked subject at a certain frame, the motion feature vector is obtained:

M=(θₐₗ,θₐᵣ,Dₕₗ,Dₕᵣ,θ_{b},D_{f},D_{sb}) (9)

For simplicity, denote each feature in M using the following format:

M=(m₁,m₂,m₃,m₃,m₅,m₆,m₇) (10)

The system is a general framework for behaviour recognition which can be easily extended to recognise more behaviour types by adding more relevant joints into the feature calculation.

### 1.2.4 Occlusion Problems and Tracking State Reliability

The sensor hardware system provides the level of the tracking reliability of the 3D joints. For example, Kinect also returns to the tracking status to indicate if a 3D joint is tracked robustly, or inferred according to the neighbouring joints, or not-tracked when the joint is completely invisible. The 3D joints, which are occluded, belong to the inferred or not-tracked part. Aptly to solve the occlusion problem and increase the reliability, certain embodiments of the present invention only perform recognition when the tracking status of the essential parts are in a tracked status to avoid misclassifications, i.e. inferred or not-tracked joint data is ignored. Optionally tracking reliability can be provided separately from the sensor units.

### 1.3 Transforming Type-1 Membership Functions to Interval Type-2 Membership Functions

FIG. 8 shows the type-1 fuzzy sets which were extracted via FCM as explained above.

In order to construct the initial type-2 MFs modelling the FOU, the type-1 fuzzy sets are transformed to the interval type-2 fuzzy sets with certain mean (m) and uncertain standard deviation σ [σₖ₁^{l}, σₖ₁^{l}] [28], [29], i.e.,

$${μ}_{k}^{l} ( {x}_{k} ) = exp [ - \frac{1}{2} ( \frac{{x}_{k} - {m}_{k}^{l}}{{σ}_{k}^{l}} ) ] , {σ}_{k}^{l} ∈ [ {σ}_{k 1}^{l} , {σ}_{k 2}^{l} ] \qquad ( 11 )$$

where k=1, . . . , p; p is the number of antecedents; l=1, . . . , R; R is the number of rules. The upper membership function of the type-2 fuzzy set can be written as follows:

μ̅ₖ^{l}(xₖ)=N(mₖ^{l},σₖ₂^{l},xₖ) (12)

The lower membership function can be written as follows:

μₖ^{l}(xₖ)=N(mₖ^{l},σₖ₁^{l},xₖ) (13)

where

$$N ( {m}_{k}^{l} , {σ}_{k}^{l} , {x}_{k} ) = exp ( - \frac{1}{2} ( \frac{{x}_{k} - {m}_{k}^{l}}{{σ}_{k}^{l}} ) ) \qquad ( 14 )$$

In order to construct the type-2 MFs for the IT2FLS, the standard deviation of the given type 1 fuzzy set (extracted by FCM clustering) is used to represent the σₖ₁^{l}. σₖ₂^{l} is obtained by blurring σₖ₁^{l} with a certain α % (α=10, 20, 30, 40 . . . ) such that

σₖ₂^{l}=(1+α%)σₖ₁^{l} (15)

where mₖ^{l} is the same as the given type-1 fuzzy set. In order to allow for a fair comparison between the type-2 fuzzy logic system and type-1 fuzzy logic system, the same input features for the IT2FLS and the T1FLS can be used.
1.4 Initial Rule Base Construction from the Raw Data

The Wang-Mendel approach, H. Hagras, “A hierarchical type-2 fuzzy logic control architecture for autonomous mobile robots,” IEEE Transactions on Fuzzy Systems, vol. 12, no. 4, pp. 524-539, 2004, can be used to construct the initial rule base of the fuzzy system which is further optimised by the BB-BC algorithm discussed hereinafter. The type-2 fuzzy system extracts various multiple-input-multiple-output rules, which model the relation between M=(m₁, . . . , mₚ) and O=(o₁, . . . , o_{q}), and use the following form:

IF m₁ is \tilde{X}₁^{r} . . . and mₚ is \tilde{X}ₚ^{r} THEN o₁ is \tilde{Y}₁^{r} . . . and o_{q} is \tilde{X}_{q}^{r} (16)

Where p is the amount of antecedents, q is the amount of consequents, r=1, . . . , R, R is the amount of the rules and r is the index of the current rule. There are Tᵢₙ interval type-2 fuzzy sets \tilde{X}ᵤ^{s}, s=1, . . . , Tᵢₙ for each input mₛ where u=1, 2, . . . , p and Tₒᵤₜ interval type-2 fuzzy sets \tilde{Y}ᵥ^{t}, t=1, . . . , Tₒᵤₜ, for each output oᵥ where v=1, 2, . . . , q.

For each training vector (m⁽ⁿ⁾; o⁽ⁿ⁾), n=1, . . . , N, where N is the amount the training date vector, the upper membership degree and lower membership degree are calculated μ̅_{\tilde{X}}_{ᵤ}_{^{s}}(mᵤ⁽ⁿ⁾) and μ_{\tilde{X}}_{ᵤ}_{^{s}}(mᵤ⁽ⁿ⁾) for each fuzzy set of each input variable \tilde{X}ᵤ^{s}, s=1, . . . , Tᵢₙ, u=1, . . . , p. After that, for each s=1, . . . , Tᵢₙ, find s*ε{1, . . . , Tᵢₙ} such that:

μ_{\tilde{X}}_{ᵤ}_{^{s*}}^{C}(mᵤ⁽ⁿ⁾)≥μ_{\tilde{X}}_{ᵤ}_{^{s}}^{C}(mᵤ⁽ⁿ⁾) (17)

Where μ_{\tilde{X}}_{ᵤ}_{^{s}}^{C} (mᵤ⁽ⁿ⁾) is the centre of the interval membership of \tilde{X}ᵤ^{s} at mᵤ⁽ⁿ⁾

$${μ}_{{\tilde{X}}_{u}^{s}}^{c} ( {m}_{u}^{( n )} ) = \frac{1}{2} [ {\overline{μ}}_{{\tilde{X}}_{u}^{s}} ( {m}_{u}^{( n )} ) + {\underline{μ}}_{{\tilde{X}}_{u}^{s}} ( {m}_{u}^{( n )} ) ] \qquad ( 18 )$$

The following rule will be referred to as the rule generated by (m⁽ⁿ⁾; o⁽ⁿ⁾):

IF m₁ is \tilde{X}₁^{s*(n)} and mₚ is \tilde{X}ₚ^{s*(n)} THEN o is centered at o⁽ⁿ⁾ (19)

An initial rule base will be constructed in this phrase. After that, conflicting rules which have the same antecedents but different consequents will be resolved by using the rule weight obtained by the following equation:

w⁽ⁿ⁾=Πᵤ₌₁^{p}μ_{\tilde{X}}_{ᵤ}_{^{s}}^{C}(mᵤ⁽ⁿ⁾) (20)

We then divide the N rules into groups such that rules in one group have the same antecedents such that:

IF m₁ is \tilde{X}₁^{r} and mₚ is \tilde{X}ₚ^{r} THEN o is centered at o^{(d}^{ₖ}^{^{r}}⁾ (19)

Where k=1, . . . , N and dₖ^{r} is the data points index of group r. Then, the weighted average of the rules in group r whose amount of rule is N, can be computed by using the following equation:

$${\overline{w}}^{( r )} = \frac{{\sum }_{k = 1}^{{N}_{r}} {o}^{( {d}_{k}^{r} )} {w}^{( {d}_{k}^{r} )}}{{\sum }_{k = 1}^{{N}_{r}} {w}^{( {d}_{k}^{r} )}} \qquad ( 21 )$$

After that, the conflicting rules in this group can be merged into one rule in the following format:

IF m₁ is \tilde{X}₁^{r} . . . and mₚ is \tilde{X}ₚ^{r} THEN o is \tilde{Y}^{r} (22)

Where the choosing of the output fuzzy set Y based is based on the following: among the Tₒᵤₜ output fuzzy sets [symbol] , . . . , [symbol] out find the Y^{t}* such that:

[symbol]

(w̅^{(r)})≥ [symbol] (w̅^{(r)}) (23)

To expand the algorithm to handle multiple outputs, the steps of Equations (21), (22) and (23) are repeated for each output. Illustrative sample fuzzy rules from the rule base are shown in Table 1.

TABLE 1
Illustrative sample fuzzy rules of a rule base.

| m₁ | m₂ | m₃ | m₄ | m₅ | m₆ | m₇ | Outputs |
|---|---|---|---|---|---|---|---|
| LOW | MEDIUM | HIGH | MEDIUM | MEDIUM | LOW | MEDIUM | o₆ is High |
| LOW | LOW | MEDIUM | HIGH | LOW | HIGH | MEDIUM | o₄ is High |
| LOW | HIGH | HIGH | LOW | LOW | HIGH | LOW | o₁, o₃ is High |
| LOW | MEDIUM | HIGH | HIGH | HIGH | MEDIUM | LOW | o₂ is High |
| MEDIUM | LOW | MEDIUM | HIGH | MEDIUM | HIGH | HIGH | o₅ is High |
| HIGH | LOW | LOW | MEDIUM | HIGH | MEDIUM | LOW | o₁, o₂ is High |
| LOW | LOW | HIGH | HIGH | LOW | HIGH | LOW | o₃ is High |

where the inputs are left-arm-angle (m₁), right-arm-angle (m₂), left-hand-distance (m₃), right-hand-distance (m₄), body-bending-angle (m₅), spine-tofloor-distance (m₆), movement-speed (m₇), and the outputs are drinking/eating-possibility (o₁), sitting-possibility (o₂), standing-possibility (o₃), walking-possibility (o₄), running-possibility (o₅), lying/falling down-possibility (o₆). For each rule in Table 1, in the outputs columns, the unshown outputs would have an associated LOW fuzzy set.

### 1.5 Optimising the IT2FLS Via BB-BC

Using FCM to generate the membership functions and using the Wang-Mendel method to construct the initial rule base before BB-BC optimisation helps obtain a good starting point in the search space, since the BB-BC quality of the optimisation is responsive to the starting state to converge fast to the optimal position.

### 1.5.1 Big Bang-Big Crunch (BB-BC) Optimisation

The BB-BC optimisation is an evolutionary approach which was presented by Erol and Eksin, O. Erol and I. Eksin, “A new optimisation method: big bang-big crunch,” Advances in Engineering Software, vol. 37, no. 2, pp. 106-111, 2006. It is derived from one of the theories of the evolution of the universe in physics and astronomy, namely the BB-BC theory. The key advantages of BB-BC are its low computational cost, ease of implementation, and fast convergence. The BB-BC theory is formed from two phases: a Big Bang phase where candidate solutions are randomly distributed over the search space in a uniform manner and a Big Crunch phase where candidate solutions are drawn into a single representative point via a centre of mass or minimal cost approach. All subsequent Big Bang phases are randomly distributed around the centre of mass or the best fit individual in a similar fashion.

The procedures followed in the BB-BC are as follows:

Step 1: (Big Bang Phase): An initial generation of N candidates is randomly generated in the search space.
Step 2: The cost function values of all the candidate solutions are computed.
Step 3: (Big Crunch Phase): The Big Crunch phase comes as a convergence operator. Either the best fit individual or the centre of mass is chosen as the centre point. The centre of mass is calculated as:

$${x}_{c} = \frac{{\sum }_{i = 1}^{N} \frac{{x}_{i}}{{f}^{i}}}{{\sum }_{i = 1}^{N} \frac{1}{{f}^{i}}} \qquad ( 24 )$$

where x_{c} is the position of the centre of mass, xᵢ is the position of the candidate, fⁱ is the cost function value of the i^{th} candidate, and N is the population size.
Step 4: New candidates are calculated around the new point calculated in Step 3 by adding or subtracting a random number whose value decreases as the iterations elapse, which can be formalised as:

$${x}^{new} = {x}_{c} + \frac{γ ρ ( {x}_{max} - {x}_{min} )}{k} \qquad ( 25 )$$

where r is a random number, p is a parameter limiting search space, xₘᵢₙ and xₘₐₓ are lower and upper limits, and k is the iteration step.
Step 5: Return to Step 2 until stopping criteria have been met.
1.5.2 Optimising the Rule Base of the IT2FLS with BB-BC

To help optimise the rule base of the IT2FLS, the parameters of the rule base are encoded into a form of a population. The IT2FLS rule base can be represented as shown in FIG. 10.

As shown in FIG. 10, mⱼ^{r} are the antecedents and ok is the consequents of each rule respectively, where j=1, . . . , p, p is the number of antecedents; k=1, . . . , q, q is the number of behaviours; r=1, . . . , R, and R is the number of the rules to be tuned. However, the values describing the rule base are discrete integers while the original BB-BC supports continuous values. Thus, instead of Equation (25), the following equation can be used in the BB-BC paradigm to round off the continuous values to the nearest discrete integer values modelling the indexes of the fuzzy set of the antecedents or consequents.

$${D}^{new} = {D}_{c} + round [ \frac{γ ρ ( {D}_{max} - {D}_{min} )}{k} ] \qquad ( 26 )$$

where D_{c} is the fittest individual, r is a random number, ρ is a parameter limiting search space, Dₘᵢₙ and Dₘₐₓ are lower and upper bounds, and k is the iteration step.

Aptly the rule base constructed by the Wang-Mendel approach is used as the initial generation of candidates. After that, the rule base can be tuned by BB-BC using the cost function depicted in Equation (27).

1.5.3 Optimising the Type-2 Membership Functions with BB-BC

To help apply BB-BC, the feature parameters of the type-2 membership function are encoded into a form of a population. As depicted in Equation (15), in order to construct the type-2 MFs, the parameter a is determined to obtain σₖ₂^{l} while σₖ₂^{l} is provided by FCM. To be more accurate, the uncertainty factors ac for each fuzzy set of the MFs are computed, where k=1, . . . , p, p is the number of antecedents; j=1, . . . , q, q is the number of input features. For illustration purposes, as in the MFs of the described system, three type-2 fuzzy sets including LOW, MEDIUM and HIGH can be utilised for modelling each of the 7 features, therefore, the total number of the parameters for the input type-2 MFs is 3×7=21. In a similar manner, parameters for the output MFs are also encoded; these are α_{L}^{Out} for the linguistic variable LOW and α_{H}^{Out} for the linguistic variable HIGH of the output MF. Therefore, the structure of the population is built as displayed in FIG. 11.

The optimisation problem is a minimisation task, and with the parameters of the MFs encoded as showed in FIG. 11 and the constructed rule base, the recognition error can be minimised by using the following function as the cost function.

fⁱ=(1−Accuracyⁱ) (27)

where fⁱ is the cost function value of the i^{th} candidate and Accuracyⁱ is the scaled recognition accuracy of the i^{th} candidate. The new candidates are generated using Equation (25).

### Recognition Phase

In the fuzzy system, the antecedents are m₁, m₂, m₃, m₄, m₅, m₆, m₇ and each of these antecedents is modelled by three fuzzy sets: LOW, MEDIUM, and HIGH. The output of the fuzzy system is the behaviour possibility which is modelled by two fuzzy sets: LOW and HIGH. The type-1 fuzzy sets shown in FIG. 8 have been obtained via FCM and the rules are the same as the IT2FLS.

When the system operates in real time, {m₁, m₂, . . . , m₇} can be measured on the current frame and the IT2FLC helps provide the possibilities of the candidate behaviour classes: drinking/eating, sitting, standing, walking, running, and lying/falling down. In the system, each activity category utilises the same output membership function as depicted in FIG. 8h, and product t-norm is employed while the centre of sets type-reduction for IT2FLS is used (for the compared type-1 FLS the centre of sets defuzzification is used). Aptly to help recognise the current behaviour, the system works in the following pattern:
The Kinect v2 is continuously capturing the raw 3D skeleton data from the subjects in the real-world intelligent environment,
Then the raw real-time 3D Sensor is analysed by a feature extraction module to get the feature vector M=(m₁, m₂, m₃, m₄, m₅, m₆, m₇) modelling the behaviour characteristics in the current frame.
For the crisp input vector M, a type-2 singleton fuzzifier is used to fuzzify the crisp input and obtain the upper μ̅_{\tilde{F}}_{₁}_{ⁱ}(x′) and lower (μ_{\tilde{F}}_{₁}_{ⁱ}(x′)) membership values.
After that, the firing strength fⁱ and f̅ⁱ of each rule is determined, where i=1, . . . , R, and R is the number of rules. Where fⁱ(x′)=μ_{F̅}_{₁}_{ⁱ}(x′₁)* . . . *μ_{\tilde{F}}_{ₚ}_{ⁱ}(x′ₚ) and f̅ⁱ(x′)=μ̅_{\tilde{F}}_{₁}_{ⁱ}(x′₁)* . . . *μ̅_{\tilde{F}}_{₁}_{ⁱ}(x′ₚ).
The type reduction is carried out by using the KM approach to compute the type reduced set defined by the interval [yₗₖ, yᵣₖ].
Next, defuzzification is computed as

$$\frac{{y}_{lk} + {y}_{rk}}{2}$$

to calculate the output degree of the target behaviour class. For one input feature vector analysed by the fuzzy system, one output degree per candidate activity class is provided, which models the possibility of the candidate activity class occurring in the current frame.

In the example given within AAL spaces, we aim at recognising the daily regular activities. However, the subject's activity sequence happening in the actual environment is not a continuous time-series due to the occlusion problems, capturing angle, and the casualness of the subject which could lead to untargeted and unknown behaviours out of our concern range. To solve this problem, certain embodiments of the present invention do not use shoulder functions in the membership functions since the target behaviours are only modelled by the feature values ranging in the sections returned by FCM learned from the feature data of the concerned activities. Additionally, a check is carried out to determine if the candidate is confident in the current frame by checking if its associated output degree is higher than a predetermined confidence threshold t. Aptly t=0.62 can be set. Aptly other values can be adopted. The confident behaviour candidates can be further considered to get a final recognition output.

In the example described and in other scenarios according to certain other embodiments of the present invention, some of the target behaviour categories are conflicting as it is impossible for them to be happening at the same moment. Therefore, the target behaviour categories are divided into several conflicting groups, i.e. sitting, standing, walking, running, and lying/falling down as a group while drinking/eating is another group.

In the final step, the behaviour recognition is performed by choosing the confident candidate behaviour category with the highest output degree as the recognised behaviour class in its behaviour group. For example, if the outputs of sitting, standing, walking, running, and lying/falling down are 0.25, 0.75, 0.64, 0.0, 0.0 and the output of drinking/eating is 0.25, then the final recognition result would be standing since its output degree is the highest among the confident candidates (which are standing and walking in this case) in the its group and the output degree of drinking/eating in the other group is lower than a confident level. Aptly if two confident candidate categories in a conflicting group are allocated with a same output degree, this demonstrates that the two candidates have extremely high behavioural similarity and cannot be distinguished in the current frame. The system may choose to ignore these two candidate categories in the behaviour recognition of the current frame.

In the described scenarios, the following behaviours can be recognised: drinking/eating, sitting, standing, walking, running, and lying/falling down. Methods have been tested including Type-1 Fuzzy Logic System (T1FLS) and Type-2 Fuzzy Logic System (T2FLS) and compared against the non-fuzzy traditional methods including Hidden Markov Models (HMM) and Dynamic Time Warping (DTW) on 15 subjects ensuring high-levels of intra- and inter-subject variation and ambiguity in behavioural characteristics.

In the training stage, the training data can be captured from different subjects where the subjects are asked to perform each target behaviour on average two to three times. In the tested experiment this resulted in around 220 activity samples for training. In the real-world recognition stage the subjects were divided into different groups and the experiments were performed with different subject numbers in a scene to model different uncertainty complexity. The experiments were conducted on average with five repetitions per target behaviour by each subject in the group analysed by the real-time behaviour recognition system. This resulted in around 1,600 activity samples for testing. To perform a fair comparison, all the methods share the same input features. As in real-world environments, occlusion problems exist in the test cases leading to behavioural uncertainty caused by the occlusions of the subjects. The experiments were conducted with different subjects and different scenes in various circumstances including different illumination strength, partial occlusions, daytime and night time, moving camera, fixed camera, different monitoring angles, etc. The experiment results demonstrate that the algorithm is robust and effective in handling the high levels of uncertainties associated with real-world environments including occlusion problems, behaviour uncertainty, activity ambiguity, and uncertain factors such as position, orientation and speed, etc.

The type-2 membership functions used in the system, which are constructed and optimised by BB-BC, are shown in FIG. 12.

Experimental results demonstrate that the BB-BC optimisation improves the performance of a type-2 fuzzy logic system. In the BB-BC optimisation procedure of the type-2 membership functions, set xₘᵢₙ and xₘₐₓ are set to 50% and 300%, which influences the FOU blurring factor α in type-2 MFs construction. In order to help achieve robust recognition performance the population size N of BB-BC is set to 200,000. In addition, owing to the high-performance of BB-BC, each iteration of the optimisation procedure can be done in a few minutes.

Based on the optimised type-2 fuzzy sets and rule base by utilising BB-BC, the IT2FLSs-based system outperforms the counterpart T1FLSs-based recognition system, as shown in Table 2, where the type-2 system achieves 5.29% higher average per-frame accuracy over the test data in the recognition phrase than the type-1 system. The type-2 fuzzy logic system also outperforms the traditional non-fuzzy based recognition methods based on Hidden Markov Models (HMM) and Dynamic Time Warping (DTW). In order to conduct a fair comparison with the traditional HMM-based and DTW-based methods, all the methods share the same input features. As shown in Table 2, the IT2FLSs-based method with BB-BC optimisation achieves 15.65% higher recognition average accuracy than the HMM-based algorithm, and 11.62% higher recognition average accuracy than the DTW-based algorithm. For the standard deviation of each subject's recognition accuracy, the T2FLS-based method is the lowest, demonstrating the stableness and robustness of the method when testing on different subjects.

When the number of subjects increases which leads to a higher possibility of occlusion and thus problems with a higher-level of behaviours uncertainty, the difference between the method compared to the T1FLS-based method and the traditional non-fuzzy methods is even higher according to certain embodiments of the present invention, as shown in Table 3, Table 4 and Table 5. The optimised T2FLS-based method according to certain embodiments of the present invention remains the most robust algorithm with the highest recognition accuracy which remains roughly the same with adding more users to the scene.

Based on the recognition results of our optimised IT2FLS, higher-level applications including video linguistic summarisations, event searching, activity retrieval, event playback, and human-machine interactions have been developed and successfully deployed in selected locations.

TABLE 2
Comparison of Fuzzy-based methods against traditional methods with
One subject per Group in a scene (Fifteen groups)

| Method | Average Accuracy | Standard Deviation |
|---|---|---|
| HMM | 70.9266% | 0.175258 |
| DTW | 74.9614% | 0.129266 |
| T1FLS | 81.2903% | 0.110410 |
| T2FLS | 86.5798% | 0.086551 |

TABLE 3
Comparison of Fuzzy-based methods against traditional methods with
Two subjects per Group in a scene (Six groups)

| Method | Average Accuracy | Standard Deviation |
|---|---|---|
| HMM | 72.4134% | 0.078800 |
| DTW | 71.6549% | 0.051693 |
| T1FLS | 79.0394% | 0.157738 |
| T2FLS | 85.8864% | 0.092471 |

TABLE 4
Comparison of Fuzzy-based methods against traditional methods with
Three subjects per Group in a scene (Five groups)

| Method | Average Accuracy | Standard Deviation |
|---|---|---|
| HMM | 70.1782% | 0.042738 |
| DTW | 73.7452% | 0.103744 |
| T1FLC | 78.3855% | 0.128380 |
| T2FLC | 86.1305% | 0.082625 |

TABLE 5
Comparison of Fuzzy-based methods against traditional methods with
Four subjects per Group in a scene (Three groups)

| Method | Average Accuracy | Standard Deviation |
|---|---|---|
| HMM | 69.5274% | 0.083920 |
| DTW | 70.1220% | 0.112780 |
| T1FLC | 76.6017% | 0.080618 |
| T2FLC | 84.7253% | 0.072113 |

The results of detected events and the associated video data are stored in the SQL Event database server so that further data mining can be performed by using event summarisation and retrieval software. Also, the user can easily summarise the event of interest at the given time frame and play them back.

FIG. 13 provides the detection results of the real-time event detection system deployed in different real-world environments. The number of subjects changes according to the application scenario. In FIG. 13a, two people are shown via one Kinect v2. In FIG. 13b, the system analyses the activity of three subjects in the scene. In FIG. 13c, behaviour recognition is performed with four subjects. As the illustrated scenario is in a living environment, the users have more freedom to act casually and the occlusion problems are more likely to happen with a large crowd of subjects, these factors lead to higher-levels of uncertainty. As can be seen, the user 1 who is drinking coffee is heavily occluded by the table in front, as well as the user 2 who is walking towards the door. The IT2FLS-based recognition system according to certain embodiments of the present invention handles the high-levels of uncertainty robustly and returns the correct results.

As shown in FIG. 14, to retrieve the interesting events and information, event retrieval and playback can be performed. In FIG. 14a, to retrieve the events of a certain subject conducted during a fixed time period, a subject number and time duration are inputted and event retrieval is performed via the front-end GUI. After that, the relevant retrieved events are shown in the result list, from where the retrieved event can be retrieved and played back as HD video. Similarly, in FIG. 14b in which the drinking activities that happened in the iSpace are of interest. Therefore, the “Drinking” activity can be selected from the event category and also a certain time period is provided. Then, the events associated with “Drinking” during the given time period are retrieved and shown in the result list for the user to play back.

Certain embodiments of the present invention provide for behaviour recognition and event linguistic summarisation utilising a RGB-D sensor Kinect v2 based on BB-BC optimised Interval Type-2 Fuzzy Logic Systems (IT2FLSs) for AAL real world environments. It has been shown that the system is capable of handling high-levels of uncertainties caused occlusions, behaviour ambiguity and environmental factors.

In the system, the input features are first extracted from the 3D Kinect data captured by the RGB-D sensor. After that, membership functions and rule base of the fuzzy system are constructed automatically based on the obtained feature vectors. Finally, a Big Bang-Big Crunch (BB-BC) based optimisation algorithm is used to tune the parameters of the fuzzy logic system for behaviour recognition and event summarisation.

For the real-world application in AAL environments, a real-time distributed analysis system has been developed including front-end user interface software for operational commands inputting, a real-time learning and recognition system to detect the users' behaviour and a back-end SQL database event server for smart event storage, high-efficient activity retrieval, and high-definition event video playback.

The system has been successfully deployed in real world environments occupied with various users ensuring high-levels of intra- and inter-subject behavioural uncertainty. Experimental results demonstrate that the BB-BC based optimisation paradigm is effective in tuning and optimising the parameters of our fuzzy system. In addition, experimental results with single users show that the proposed IT2FLS handles the high-levels of uncertainties well and achieves robust recognition of 86.57% and outperforms the T1FLS counterpart by an enhancement of 5.28% as well as other traditional non-fuzzy systems including the HMM-based system and DTW-based method by 15.65% and 11.61%, respectively. Moreover, it has been shown that the proposed IT2FLS delivers consistent and robust recognition accuracy while the T1FLS and other conventional methods based on HMM and DTW show degradations in recognition accuracy when increasing the number of users.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of determining behavior of a plurality of candidate objects in a multi-candidate object scene, the method comprising:
extracting behavior features frame-by-frame from video data associated with a scene;
providing the behavior features to an input of a recognition system comprising an Interval Type 2 Fuzzy Logic (IT2FLS) based recognition model; and
classifying candidate object behavior for a plurality of candidate objects in a current frame by selecting a candidate behavior model with a highest output degree for each candidate object.

2. The method as claimed in claim 1, wherein selecting said candidate behavior model comprises selecting a candidate model from a plurality of possible candidate behavior models of the recognition model, each possible candidate behavior model comprising a respective output degree for a target candidate object in a frame and the candidate behavior model the candidate model with the highest output degree.

3. The method as claimed in claim 2, wherein:
selecting said candidate model comprises selecting a candidate behavior model from at least one confident candidate behavior model that has a calculated confidence level above a predetermined threshold.

4. The method as claimed in claim 1, further comprising:
providing behavior features as a crisp feature vector M that models behavior characteristics in a current frame, by:
M=(m₁,m₂,m₃,m₃,m₅,m₆,m₇),
wherein M is a motion feature vector and m₁ is an angle feature of a left arm, m₂ is an angle feature of a right arm θₐᵣ, m₃ and m₄ are position features Dₕₗ, Dₕₗ of vectors \vec{PₛₛPₕₗ}, \vec{PₛₛPₕᵣ}, m₅ is a bending angle, m₆ is a distance D_{f} between 3D coordinates Spine Base P_{sb} to a 3D Plane of a floor in a vertical direction, and m₇ is a movement speed D_{sb}.

5. The method as claimed in claim 4, further comprising:
fuzzifying the crisp feature vector M via a type 2 singleton fuzzifier in order to provide an upper and lower membership value.

6. The method as claimed in claim 5, further comprising:
determining a firing strength for each of R rules.

7. The method as claimed in claim 6, further comprising:
determining a reduced set defined by an interval:
[Yₗₖ,Yᵣₖ]
wherein Yₗₖ Yᵣₖ are left and right end points of type reduced sets.

8. (canceled)

9. (canceled)

10. The method as claimed in claim 1, further comprising:
continually monitoring the scene via a plurality of high definition (HD) video sensors each providing a respective stream of consecutive image frames.

11. The method as claimed in claim 1, further comprising:
in response to the detection of predetermined events, determining at least one associated information element and providing corresponding summarized event data for the detected event; and
storing the summarized event data in a database.

12. The method as claimed in claim 11, further comprising:
storing the summarized event data in the database as a record associated with a particular frame or range of frames of video data.

13. A method of providing an Interval Type 2 Fuzzy Logic (IT2FLS) based recognition system for a video monitoring system that can determine behavior of a plurality of candidate objects in a multi candidate object scene, the method comprising:
extracting features frame-by-frame from video data depicting at least one candidate object performing a predetermined behavior;
providing Type-1 fuzzy membership functions for the extracted features;
transforming each Type-1 membership function to a Type-2 membership function; and
generating an initial rule base including a plurality of multiple input-multiple output rules responsive to the extracted features.

14. The method as claimed in claim 13, further comprising:
for each behavior to be recognized by the recognition system, providing a feature vector M that models behavior characteristics of a predetermined behavior, by:
M=(m₁,m₂,m₃,m₃,m₅,m₆,m₇)
wherein M is a motion feature vector and m₁ is an angle feature of a left arm, m₂ is an angle feature of a right arm θₐᵣ, m₃ and m₄ are position features Dₕₗ, Dₕₗ of vectors \vec{PₛₛPₕₗ}, \vec{PₛₛPₕᵣ}, m₅ is a bending angle, m₆ is a distance D_{f} between 3D coordinates Spine Base P_{sb} to a 3D Plane of a floor in a vertical direction, and m₇ is a movement speed D_{sb}.

15. (canceled)

16. The method as claimed in claim 13, further comprising:
providing an optimized rule base for the recognition system via big bang-big crunch (BB-BC) optimization of the initial rule base.

17. (canceled)

18. The method as claimed in claim 13, further comprising:
providing an optimized Type-2 membership function for the recognition system via big bang-big crunch (BB-BC) optimization of the Type-2 membership function.

19. The method as claimed in claim 13, wherein providing Type-1 fuzzy membership functions comprises providing Type-1 fuzzy membership functions via a clustering method that classifies unlabeled data by minimizing an objective function.

20. The method as claimed in claim 13, further comprising:
providing the video data by continuously or repeatedly capturing an image at a scene comprising a candidate object via at least one sensor element.

21. The method as claimed in claim 13, further comprising:
extracting features by providing at least one of: a joint-angle feature representation, a joint-position feature representation, a posture representation or a tracking reliability status for joints identified.

22. A non-transitory computer readable medium comprising a computer program with program instructions for determining behavior of a plurality of candidate objects in a multi-candidate object scene by the method as claimed in claim 1.

23. An apparatus for determining behavior of a plurality of candidate objects in a multi-candidate object scene, comprising:
at least one sensor for configured to provide video data associated with a scene;
at least one feature extraction system configured to extract behavior features from the video data; and
at least one Interval Type 2 Fuzzy Logic System (IT2FLS) based recognition system configured to receive the behavior features and classify candidate object behavior for a plurality of candidate objects in a current frame by selecting a candidate behavior model with a highest output degree for each candidate object.

24. The apparatus as claimed in claim 23, further comprising:
at least one database configured to be searchable by inputting one or more behavior marks and provide one or more frames comprising image data including at least one candidate object with a predetermined behavior associated with input marks.

25. (canceled)

26. (canceled)
